(19) United States
(12) Patent Application Publication
(10) Pub. No.: US 2024/0259950 A1
(43) Pub. Date: Aug. 1, 2024

(54) FRAMEWORK FOR POWER CONTROL STATES

(71) Applicant: Telefonaktiebolaget LM Ericsson (publ), Stockholm (SE)

(72) Inventors: Andreas Nilsson, Göteborg (SE); Shiwei Gao, Nepean (CA); Helka-Liina Määttänen, Helsinki (FI); Siva Muruganathan, Stittsville (CA); Jianwei Zhang, Solna (SE)

(21) Appl. No.: 18/019,269

(22) PCT Filed: Aug. 5, 2021
(86) PCT No.: PCT/IB2021/057220

§ 371 Date: Feb. 2, 2023

Related U.S. Application Data
(60) Provisional application No. 63/061,697, filed on Aug. 5, 2020.

(51) Int. Cl. H04W 52/14; H04W 52/42

(52) U.S. Cl. CPC H04W 52/146; H04W 52/42

(57) ABSTRACT

Systems and methods for associating power control states with Transmission Configuration Indicator (TCI) states are provided. In some embodiments, a method performed by a wireless communication device comprises obtains information that indicates associations between two or more power control states and: (a) two or more TCI states, (b) two or more uplink (UL) channels, (c) two or more UL resources, (d) two or more UL resource sets, (e) two or more UL resource groups, or (f) any combination of two or more of (a)-(e). In this way, some embodiments herein enable efficient signaling to associate the TCI states with the power control states.

### RELATED APPLICATIONS

This application claims the benefit of provisional patent application Ser. No. 63/061,697, filed Aug. 5, 2020, the disclosure of which is hereby incorporated herein by reference in its entirety.

### TECHNICAL FIELD

The present disclosure relates to signaling and a framework for associating power control states with Transmission Configuration Indicator (TCI) states and/or uplink (UL) channels/UL resources/UL resource sets/UL resource groups.

### BACKGROUND

The next generation mobile wireless communication system (5G), or New Radio (NR), will support a diverse set of use cases and a diverse set of deployment scenarios. The later includes deployment at both low frequencies (below 6 GHZ) and very high frequencies (up to 10's of GHz).

### NR Frame Structure and Resource Grid

NR uses Cyclic Prefix Orthogonal Frequency Division Multiplexing (CP-OFDM) in both downlink (DL) (i.e., from a network node, new radio base station (gNB), or base station, to a user equipment (UE)) and uplink (UL) (i.e., from UE to gNB). Discrete Fourier Transform (DFT) spread OFDM is also supported in the uplink. In the time domain, NR downlink and uplink are organized into equally sized subframes of 1 ms each. A subframe is further divided into multiple slots of equal duration. The slot length depends on subcarrier spacing. For subcarrier spacing of Δf=15 kHz, there is only one slot per subframe, and each slot consists of 14 OFDM symbols.

Data scheduling in NR is typically in slot basis, an example is shown in FIG. 1 with a 14-symbol slot, where the first two symbols contain Physical Downlink Control Channel (PDCCH) and the rest contains physical shared data channel, either Physical Downlink Shared Channel (PDSCH) or Physical Uplink Shared Channel (PUSCH).

Different subcarrier spacing values are supported in NR. The supported subcarrier spacing values (also referred to as different numerologies) are given by Δf=(15×24) kHz where μ∈{0,1,2,3,4}. Δf=15 kHz is the basic subcarrier spacing. The slot durations at different subcarrier spacings is given by 1/2μ ms.

In the frequency domain, a system bandwidth is divided into resource blocks (RBs), each corresponds to 12 contiguous subcarriers. The RBs are numbered starting with 0 from one end of the system bandwidth. The basic NR physical time-frequency resource grid is illustrated in FIG. 2, where only one RB within a 14-symbol slot is shown. One OFDM subcarrier during one OFDM symbol interval forms one resource element (RE).

DL PDSCH transmissions can be either dynamically scheduled, i.e., in each slot the gNB transmits Downlink Control Information (DCI) over PDCCH about which UE data is to be transmitted to and which RBs in the current downlink slot the data is transmitted on, or semi-persistently scheduled (SPS) in which periodic PDSCH transmissions are activated or deactivated by a DCI. Different DCI formats are defined in NR for DL PDSCH scheduling including DCI format 1_0, DCI format 1_1, and DCI format 1_2.

Similarly, UL PUSCH transmission can also be scheduled either dynamically or semi-persistently with uplink grants carried in PDCCH. NR supports two types of semi-persistent uplink transmission, i.e., type 1 configured grant (CG) and type 2 configured grant, where Type 1 configured grant is configured and activated by Radio Resource Control (RRC) while type 2 configured grant is configured by RRC but activated/deactivated by DCI. The DCI formats for scheduling PUSCH include DCI format 0_0, DCI format 0_1, and DCI format 0_2.

Transmission with Multiple Beams

In high frequency range (FR2), multiple radio frequency (RF) beams may be used to transmit and receive signals at a gNB and a UE. For each DL beam from a gNB, there is typically an associated best UE Rx beam for receiving signals from the DL beam. The DL beam and the associated UE Rx beam forms a beam pair. The beam pair can be identified through a so-called beam management process in NR.

A DL beam is identified by an associated DL Reference Signal (RS) transmitted in the beam, either periodically, semi-persistently, periodically. The DL RS for the purpose can be a Synchronization Signal (SS) and Physical Broadcast Channel (PBCH) block (SSB) or a Channel State Information RS (CSI-RS). For each DL RS, a UE can do an Rx beam sweep to determine the best Rx beam associate with the DL beam. The best Rx beam for each DL RS is then memorized by the UE. By measuring all the DL RSs, the UE can determine and report to the gNB the best DL beam to use for DL transmissions.

With the reciprocity principle, the same beam pair can also be used in the UL to transmit a UL signal to the gNB, often referred to as beam correspondence.

An example is shown in FIG. 3, where a gNB consists of a transmission point (TRP) with two DL beams each associated with a CSI-RS and one SSB beam. Each of the DL beams is associated with a best UE Rx beam, i.e., Rx beam #1 is associated with the DL beam with CSI-RS #1 and Rx beam #2 is associated with the DL beam with CSI-RS #2.

Due to UE movement or environment change, the best DL beam for a UE may change over time and different DL beams may be used in different times. The DL beam used for a DL data transmission in PDSCH can be indicated by a Transmission Configuration Indicator (TCI) field in the corresponding DCI scheduling the PDSCH or activating the PDSCH in case of SPS. The TCI field indicates a TCI state which contains a DL RS associated with the DL beam. In the DCI, a Physical Uplink Control Channel (PUCCH) resource is indicated for carrying the corresponding Hybrid Automatic Repeat Request (HARQ) A/N. The UL beam for carrying the PUCCH is determined by a PUCCH spatial relation activated for the PUCCH resource. For PUSCH transmission, the UL beam is indicated indirectly by a Sounding Reference Signal (SRS) Resource Indicator (SRI), which points to one or more SRS resources associated with the PUSCH transmission. The SRS resource(s) can be periodic, semi-persistent, or aperiodic. Each SRS resource is associated with an SRS spatial relation in which a DL RS (or another periodic SRS) is specified. The UL beam for the PUSCH is implicitly indicated by the SRS spatial relation(s).

### Spatial Relations

Spatial relation is used in NR to refer to a spatial relationship between an UL channel or signal, such as PUCCH, PUSCH, and SRS, and a DL (or UL) RS, such as CSI-RS, SSB, or SRS. If an UL channel or signal is spatially related to a DL RS, it means that the UE should transmit the UL channel or signal with the same beam used in receiving the DL RS previously. More precisely, the UE should transmit the UL channel or signal with the same spatial domain transmission filter used for the reception of the DL RS.

If a UL channel or signal is spatially related to a UL SRS, then the UE should apply the same spatial domain transmission filter for the transmission for the UL channel or signal as the one used to transmit the SRS.

For PUCCH, up to 64 spatial relations can be configured for a UE and one of the spatial relations is activated by a Medium Access Control (MAC) Control Element (CE) for each PUCCH resource.

FIG. 4 is a PUCCH spatial relation information element (IE) that a UE can be configured in NR, it includes one of a SSB index, a CSI-RS resource identity (ID), and SRS resource ID as well as some power control parameters such as pathloss RS, closed-loop index, etc.

For each periodic and semi-persistent SRS resource or aperiodic SRS with usage “non-codebook” configured, its associated DL CSI-RS is RRC configured. For each aperiodic SRS resource with usage “codebook” configured, the associated DL RS is specified in an SRS spatial relation activated by a Medium Access Control Element (MAC CE). An example of SRS spatial relation information element is shown in FIG. 5, where one of a SSB index, a CSI-RS resource identity (ID), and SRS resource ID is configured.

For PUSCH, its spatial relation is defined by the spatial relation of the corresponding SRS resource(s) indicated by the SRI in the corresponding DCI.

### Uplink Power Control in NR

Uplink power control is used to determine a proper transmit power for PUSCH, PUCCH and SRS to ensure that they are received by the gNB at an appropriate power level. The transmit power will depend on the amount of channel attenuation, the noise and interference level at the gNB receiver, and the data rate in case of PUSCH or PUCCH.

The uplink power control in NR consists of two parts, i.e., open-loop power control and closed-loop power control. Open-loop power control is used to set the uplink transmit power based on the pathloss estimation and some other factors including the target receive power, channel/signal bandwidth, modulation and coding scheme (MCS), fractional power control factor, etc.

Closed-loop power control is based on explicit power control commands received from the gNB. The power control commands are typically determined based on some UL measurements at the gNB on the actual received power. The power control commands may contain the difference between the actual and the target received powers. Either cumulative or non-cumulative closed-loop power adjustments are supported in NR. Up to two closed loops can be configured in NR for each UL channel or signal. A closed loop adjustment at a given time is also referred as a power control adjustment state.

With multi-beam transmission in FR2, pathloss estimation needs to also reflect the beamforming gains corresponding to an uplink transmit and receive beam pair used for the UL channel or signal. This is achieved by estimating the pathloss based on measurements on a downlink RS transmitted over the corresponding downlink beam pair. The DL RS is referred to as a DL pathloss RS. A DL pathloss RS can be a CSI-RS or SSB. For the example shown in FIG. 3, when a UL signal is transmitted in beam #1, CSI-RS #1 may be configured as the pathloss RS. Similarly, if a UL signal is transmitted in beam #2, CSI-RS #2 may be configured as the pathloss RS.

For a UL channel or signal (e.g., PUSCH, PUCCH, or SRS) to be transmitted in a UL beam pair associated with a pathloss RS with index k, it transmit power in a l (l=0,1) occasion i within a slot in a bandwidth part (BWP) of a carrier frequency of a serving cell and a closed-loop index l (l=0,1) can be expressed as

$$P ( i , k , l ) = min \{ \begin{matrix}{P}_{CMAX} ( i ) \\ {P}_{open - loop} ( i , k ) + {P}_{closed - loop} ( i , l )\end{matrix}$$

where P_{CMAX}(i) is the configured UE maximum output power for the carrier frequency of the serving cell in transmission occasion i for the UL channel or signal. Pₒₚₑₙ₋ₗₒₒₚ(i,k) is the open loop power adjustment and P_{closed-loop}(i,l) is the closed loop power adjustment. Pₒₚₑₙ₋ₗₒₒₚ(i,k) is given below,

$${P}_{open - loop} ( i , k ) = {P}_{O} + {P}_{RB} ( i ) + α P L ( k ) + Δ ( i )$$

where P_{O} is the nominal target receive power for the UL channel or signal and comprises a cell specific part P_{O,cell} and a UE specific part P_{O,UE}, P_{RB} (i) is a power adjustment related to the number of RBs occupied by the channel or signal in a transmission occasion i, PL(k) is the pathloss estimation based on a pathloss reference signal with index k, a is fractional pathloss compensation factor, and Δ(i) is a power adjustment related to MCS. P_{closed-loop}(i,l) is given below:

$${P}_{closed - loop} ( i , l ) = \{ \begin{matrix}{P}_{closed - loop} ( i - {i}_{0} , l ) + {\sum }_{m = 0}^{M} δ ( m , l ) ; if cumulation is enabled \\ δ ( i , l ) ; if cumulation is disable ( i . e . , absolute is enable )\end{matrix}$$

where δ(i,l) is a transmit power control (TPC) command value included in a DCI format associated with the UL channel or signal at transmission occasion i and closed-loop l; Σₘ₌₀^{M}δ(m,l) is a sum of TPC command values that the UE receives for the channel or signal and the associated closed-loop l since the TPC command for transmission occasion i-i₀.

Note that power control parameters P_{O}, P_{RB}(i), α, PL, Δ(i), δ(i,l) are generally configured separately for each UL channel or signal (e.g., PUSCH, PUCCH, and SRS) and may be different for different UL channels or signals.

### Power Control for SRS

For SRS, pathloss RS and other power control parameters (e.g., P_{O}, α, etc.) are configured for each SRS resource set. In NR Rel-16, a list of pathloss RS may be configured for an SRS resource set and one pathloss RS is activated/selected by a MAC CE. Note that for each BWP in a serving cell, there can only be one SRS resource set configured with usage set to either “codebook” or “non-codebook” in NR.

For SRS closed-loop power control, a UE can have a dedicated closed loop for SRS or share the closed loop(s) of PUSCH in the same serving cell. This is configured by a higher layer parameter srs-PowerControlAdjustmentStates in each SRS resource set to select one out of three options, i.e., use the dedicated closed loop for SRS, the first closed loop, and the second closed loop for PUSCH. In case that the closed loop(s) are shared with PUSCH, P_{closed-loop}(i,l) for PUSCH also applies to SRS transmitted in the SRS resource set.

For the dedicated closed loop configured for SRS, δ(m,l) corresponds to a TPC command received in DCI format 2_3 for the UE. The mapping between the 2 bits TPC command field in DCI and power adjustment values in dB are shown in Table 1.

### Power Control for PUSCH

For PUSCH, P_{O}=P_{O,nominal_PUSCH}+P_{O,UE_PUSCH}, where P_{O,nominal_PUSCH} is cell specific and is RRC configured, and P_{O,UE_PUSCH} is UE specific and can be dynamically selected.

For dynamically scheduled PUSCH, as illustrated in FIG. 6, a UE is configured by RRC with a list of P0-PUSCH-Alpha sets and a list of SRI-PUSCH-PowerControl information elements. One SRI-PUSCH-PowerControl is selected by the SRI field in DCI (e.g., DCI formats 0_1, 0_2). Each SRI-PUSCH-PowerControl IE consists of a PUSCH pathloss RS ID, a closed-loop index, and a P0-PUSCH-AlphaSet ID, where a P0-PUSCH-AlphaSet comprises a P_{O,UE_PUSCH} and α. δ(i,l) is indicated in a 2 bits TPC command field of the same DCI, where the mapping between the field value and the dB value is shown in Table 1.

In NR Rel-16, additional one or two sets of P0-PUSCH-r16 can be configured for each SRI for Ultra-Reliable Low-Latency Communication (URLLC) traffic. One set can be configured if SRI is present in UL DCI format 0_1 or DCI format 0_2 and whether the P0 associated with the SRI or the set of P0 configured for URLLC should be used for a PUSCH can be dynamically indicated in a “Open-loop power control parameter set indication” field in UL DCI. Two sets can be configured if SRI is not present in UL DCI and one of the two P0-PUSCH-r16 sets and the first P0-PUSCH-AlphaSet can be dynamically indicated in the “Open-loop power control parameter set indication” field in UL DCI.

If the PUSCH transmission is scheduled by a DCI format that does not include a SRI field, or if SRI-PUSCHPowerControl is not provided to the UE, the UE determines P_{O,UE_PUSCH} and a from the value of the first P0-PUSCH-AlphaSet.

In addition to TPC command field in DCI scheduling a PUSCH, PUSCH power control for a group of UEs is also supported by DCI format 2_2 with Cyclic Redundancy Check (CRC) scrambled by TPC-PUSCH-RNTI, in which power adjustments for multiple UEs can be signaled simultaneously.

TABLE 1
Mapping of TPC Command Field in DCI formats
0_0, 0_1, 0_2, 2_2 for PUSCH or DCI format 2_3
for SRS to absolute and accumulated values.

| TPC | Accumulated | Absolute δ |
|---|---|---|
| Command Field | δ(m, l) [dB] | (m, l) [dB] |
| 0 | −1 | −4 |
| 1 | 0 | −1 |
| 2 | 1 | 1 |
| 3 | 3 | 4 |

For PUSCH with configured grant, P_{O}, α and closed loop index are semi-statically configured by RRC. For CG with RRC configured pathloss RS, the RS is used for pathloss estimation, otherwise, the pathloss RS indicated in the DCI activating the CG PUSCH is used for pathloss estimation.

### Power Control for PUCCH

For PUCCH, P_{O}=P_{O,nominal_PUCCH}+P_{O,UE_PUCCH} and α=1, where P_{O,nominal_PUCCH} is RRC configured cell specific parameter and P_{O,UE_PUCCH} is a UE specific parameter and can vary among different PUCCH resources. A UE is configured with a list of up to 8 P_{O,UE_PUCCH} (each with a P0-PUCCH-Id) and a list of up to 8 pathloss RS (each with a pucch-PathlossReferenceRS-Id). For each PUCCH resource, a PUCCH spatial relation (i.e., PUCCH-SpatialRelationInfo) is activated in which a closed-loop index, a pathloss RS (from the corresponding list), and a P_{O,UE_PUCCH} (from the corresponding list) are configured.

For closed loop power adjustment for PUCCH, up to two control loops may be configured. Accumulation is always enabled. TPC command for PUCCH HARQ A/N can be received in either DCI formats 1_0, 1_1 and 1_2 scheduling the corresponding PDSCH or in DCI format 2_2 when the DCI is scrambled with TPC-PUCCH-RNTI. The mapping between a TPC field value in DCI and a power correction value in dB is shown in Table 2.

TABLE 2
Mapping of TPC Command Field in DCI format
1_0 or DCI format 1_1 or DCI format 1_2 or DCI format
2_2 to accumulated δ (m, l) values for PUCCH

| TPC | Accumulated δ |
|---|---|
| Command Field | (m, l) [dB] |
| 0 | −1 |
| 1 | 0 |
| 2 | 1 |
| 3 | 3 |

### UL Transmission to Multiple TRPs

PDSCH transmission with multiple transmission points has been introduced in 3GPP for NR Rel-16, in which a transport block may be transmitted over multiple TRPs to improve transmission reliability.

In NR Rel-17, it has been proposed to introduce UL enhancement with multiple TRPs by transmitting a PUCCH or PUSCH towards to different TRPs as shown in FIG. 7, either simultaneously or in different times.

In one scenario, multiple PUCCH/PUSCH transmissions each towards a different TRP may be scheduled by a single DCI. For example, multiple spatial relations may be activated for a PUCCH resource and the PUCCH resource may be signaled in a DCI scheduling a PDSCH. The HARQ A/N associated with the PDSCH is then carried by the PUCCH which is then repeated multiple times either within a slot or over multiple slots, each repetition is towards a different TRP. An example of a single DCI triggered PUCCH repetitions each towards a different TRP is shown in FIG. 8, where a PDSCH is scheduled by a DCI and the corresponding HARQ A/N is sent in a PUCCH which is repeated twice in time, one towards TRP #1 and the other towards TRP #2. Each TRP is associated with a PUCCH spatial relation.

An example of PUSCH repetitions each towards a different TRP is shown in FIG. 9, where two PUSCH repetitions for a same TB are scheduled by a single DCI, each PUSCH occasion is towards a different TRP. Each TRP is associated with an SRI or a UL TCI state signaled in the UL DCI.

### TCI States

### DL TCI States

Several signals can be transmitted from different antenna ports of a same base station. These signals can have the same large-scale properties such as Doppler shift/spread, average delay spread, or average delay. These antenna ports are then said to be quasi co-located (QCL).

If the UE knows that two antenna ports are QCL with respect to a certain parameter (e.g., Doppler spread), the UE can estimate that parameter based on one of the antenna ports and apply that estimate for receiving signal on the other antenna port.

For example, the TCI state may indicate a QCL relation between a CSI-RS for Tracking Reference Signal (TRS) and the PDSCH DeModulation Reference Signal (DMRS). When UE receives the PDSCH DMRS it can use the measurements already made on the TRS to assist the DMRS reception.

Information about what assumptions can be made regarding QCL is signaled to the UE from the network. In NR, four types of QCL relations between a transmitted source RS and transmitted target RS were defined:
Type A: {Doppler shift, Doppler spread, average delay, delay spread}
Type B: {Doppler shift, Doppler spread}
Type C: {average delay, Doppler shift}
Type D: {Spatial Rx parameter}

For dynamic beam and TRP indication, a UE can be configured through RRC signaling with up to 128 TCI states for PDSCH in FR2 and up to 8 in FR1, depending on UE capability. Each TCI state contains QCL information, i.e. one or two DL RSs, each RS associated with a QCL type. The TCI states can be interpreted as a list of possible DL beams/TRPs for PDSCH transmissions to the UE.

For PDSCH transmission, up to 8 TCI states or pair of TCI states may be activated and a UE may be dynamically indicated by a TCI codepoint in DCI one or two of the activated TCI states for PDSCH reception. The UE shall use the TCI-State according to the value of the ‘Transmission Configuration Indication’ field in the detected PDCCH with DCI for determining PDSCH antenna port quasi co-location.

### UL TCI States

The existing way of using spatial relation for UL beam indication in NR is cumbersome and inflexible. To facilitate UL beam selection for UEs equipped with multiple panels, a unified TCI framework for UL fast panel selection is to be evaluated and introduced in NR Rel-17. Similar to DL, where TCI states are used to indicate DL beams/TRPs, TCI states may also be used to select UL panels and beams used for UL transmissions (i.e., PUSCH, PUCCH, and SRS).

It is envisioned that UL TCI states are configured by higher layers (i.e., RRC) for a UE in number of possible ways. In one scenario, UL TCI states are configured separately from the DL TCI states and each uplink TCI state may contain a DL RS (e.g., NZP CSI-RS or SSB) or an UL RS (e.g., SRS) to indicate a spatial relation. The UL TCI states can be configured either per UL channel/signal or per BWP such that the same UL TCI states can be used for PUSCH, PUCCH, and SRS. Alternatively, a same list of TCI states may be used for both DL and UL, hence a UE is configured with a single list of TCI states for both UL and DL beam indication. The single list of TCI states in this case can be configured either per UL channel/signal or per BWP information elements.

### SUMMARY

Embodiments of framework for power control states are disclosed herein. In one embodiment, a method performed by a wireless communication device comprises obtaining information that indicates associations between two or more power control states and: (a) two or more Transmission Configuration Indicator (TCI) states, (b) two or more UL channels, (c) two or more UL resources, (d) two or more UL resource sets, (e) two or more UL resource groups, or (f) any combination of two or more of (a)-(e); and performing one or more UL transmissions based on the information. Embodiments of the solutions disclosed herein enable efficient signaling to associate UL TCI states with power control states.

In one embodiment, the two or more TCI states are two or more uplink (UL) TCI states.

In one embodiment, the information indicates associations between the two or more power control states and the (a) two or more TCI states.

In one embodiment, the information indicates associations between the two or more power control states and the (b) two or more UL channels.

In one embodiment, the information indicates associations between the two or more power control states and the (c) two or more UL resources.

In one embodiment, the information indicates associations between the two or more power control states and the (d) two or more UL resource sets.

In one embodiment, the information indicates associations between the two or more power control states and the (e) two or more UL resource groups.

In one embodiment, the information further comprises an UL channel configuration that implicitly associates two or more TCI sates to a power control state.

In one embodiment, each power control state of the two or more power control states comprises one or more UL power control related parameters.

In one embodiment, the one or more UL power control related parameters comprise: (i) P₀, (ii) α, (iii) a pathloss Reference Signal (RS) (iv) a closed loop index, or (v) any combination of two or more of (i)-(iv).

In one embodiment, the information further indicates associations between the two or more power states and the two or more TCI states for all UL channels, all UL resources, all UL resource sets, or all UL resource groups.

In one embodiment, the information further indicates associations between the two or more power states and the two or more TCI states on a per UL channel, per UL resource, per UL resource set, and/or per UL resource group basis.

In one embodiment, the information is comprised explicitly in TCI state configurations for the two or more TCI states.

In one embodiment, the information comprises configuration of an identifier of a power control state in the configuration of each of the two or more TCI states.

In one embodiment, the information is applicable to at least one of (1) a physical uplink control channel (PUCCH); (2) a physical uplink shared channel (PUSCH); and (3) a sounding reference signal (SRS).

In one embodiment, the information comprises configuration of one or more identifiers of one or more power control states in the configuration of each of the two or more TCI states.

In one embodiment, the one or more identifiers are specific to at least one of (1) a PUCCH; (2) a PUSCH; and (3) an SRS.

In one embodiment, the information is comprised explicitly in a list or other data structure that provides mappings between the two or more power control states and the two or more TCI states.

In one embodiment, each of the mapping among one or more mappings comprises associating an identifier of each of the TCI states of the two or more TCI states to an identifier of one of the power control states among the two or more power control states.

In one embodiment, each of the mapping is applicable to at least one of (1) a PUCCH; (2) a PUSCH; and (3) an SRS.

In one embodiment, each of the mapping among one or more mappings comprises associating an identifier of each of the TCI states of the two or more TCI states to two or more identifiers of two or more power control states.

In one embodiment, each of the identifiers of the two or more power control states are applicable to at least one of (1) a PUCCH; (2) a PUSCH; and (3) an SRS.

In one embodiment, the wireless communication device is configured with two or more groups of TCI states and two or more groups of power control states; and the information that indicates the associations comprises pointers comprised in UL channel configurations for two or more UL channels. The pointers point to power control states in different groups of power control states depending on an indicated TCI state for a respective UL transmission.

In one embodiment, the wireless communication device is configured with two or more groups of TCI states and a single group of power control states; and the information that indicates the associations comprises pointers comprised in UL channel configurations for two or more UL channels. The pointers comprise, for each UL channel configuration, separate pointers for separate power control states for different ones of the two or more groups of TCI states.

In one embodiment, the wireless communication device is further configured with a set of relative power control states.

In one embodiment, group based power control signaling for the UL transmissions is used.

In one embodiment, a wireless communication device is adapted to obtain information that indicates associations between two or more power control states and: (a) two or more TCI states, (b) two or more UL channels, (c) two or more UL resources, (d) two or more UL resource sets, (e) two or more UL resource groups, or (f) any combination of two or more of (a)-(e); and perform one or more UL transmissions based on the information.

In one embodiment, a wireless communication device comprises one or more transmitters; one or more receivers; and processing circuitry associated with the one or more transmitters and the one or more receivers, the processing circuitry configured to cause the wireless communication device to obtain information that indicates associations between two or more power control states and: (a) two or more TCI states, (b) two or more UL channels, (c) two or more UL resources, (d) two or more UL resource sets, (e) two or more UL resource groups, or (f) any combination of two or more of (a)-(e); and perform one or more UL transmissions based on the information.

Corresponding embodiments of a base station and methods performed by the base station are also disclosed.

In one embodiment, a method performed by a base station comprises providing, to one or more wireless communication devices, information that indicates associations between two or more power control states and: (a) two or more TCI states, (b) two or more UL channels, (c) two or more UL resources, (d) two or more UL resource sets, (e) two or more UL resource groups, or (f) any combination of two or more of (a)-(e).

In one embodiment, the two or more TCI states are two or more UL TCI states.

In one embodiment, the information indicates associations between the two or more power control states and the (a) two or more TCI states.

In one embodiment, the information indicates associations between the two or more power control states and the (b) two or more UL channels.

In one embodiment, the information indicates associations between the two or more power control states and the (c) two or more UL resources.

In one embodiment, the information indicates associations between the two or more power control states and the (d) two or more UL resource sets.

In one embodiment, the information indicates associations between the two or more power control states and the (e) two or more UL resource groups.

In one embodiment, the information further comprises an UL channel configuration that implicitly associates two or more TCI sates to a power control state.

In one embodiment, each power control state of the two or more power control states comprises one or more UL power control related parameters.

In one embodiment, the one or more UL power control related parameters comprise: (i) P₀, (ii) α, (iii) a pathloss RS (iv) a closed loop index, or (v) any combination of two or more of (i)-(iv).

In one embodiment, the information further indicates associations between the two or more power states and the two or more TCI states for all UL channels, all UL resources, all UL resource sets, or all UL resource groups.

In one embodiment, the information further indicates associations between the two or more power states and the two or more TCI states on a per UL channel, per UL resource, per UL resource set, and/or per UL resource group basis.

In one embodiment, the information is comprised explicitly in TCI state configurations for the two or more TCI states.

In one embodiment, the information comprises configuration of an identifier of a power control state in the configuration of each of the two or more TCI states.

In one embodiment, the information is applicable to at least one of (1) a PUCCH; (2) a PUSCH; and (3) an SRS.

In one embodiment, the information comprises configuration of one or more identifiers of one or more power control states in the configuration of each of the two or more TCI states.

In one embodiment, the one or more identifiers are specific to at least one of (1) a PUCCH; (2) a PUSCH; and (3) an SRS.

In one embodiment, the information is comprised explicitly in a list or other data structure that provides mappings between the two or more power control states and the two or more TCI states.

In one embodiment, each of the mapping among one or more mappings comprises associating an identifier of each of the TCI states of the two or more TCI states to an identifier of one of the power control states among the two or more power control states.

In one embodiment, each of the mapping is applicable to at least one of (1) a PUCCH; (2) a PUSCH; and (3) an SRS.

In one embodiment, each of the mapping among one or more mappings comprises associating an identifier of each of the TCI states of the two or more TCI states to two or more identifiers of two or more power control states.

In one embodiment, each of the identifiers of the two or more power control states are applicable to at least one of (1) a PUCCH; (2) a PUSCH; and (3) an SRS.

In one embodiment, the information that indicates the associations comprises pointers comprised in UL channel configurations for two or more UL channels. The pointers point to power control states in different groups of power control states depending on an indicated TCI state for a respective UL transmission.

In one embodiment, the information that indicates the associations comprises pointers comprised in UL channel configurations for two or more UL channels. The pointers comprise, for each UL channel configuration, separate pointers for separate power control states for different ones of the two or more groups of TCI states.

In one embodiment, group based power control signaling for the UL transmissions is used.

In one embodiment, a base station is adapted to provide, to one or more wireless communication devices, information that indicates associations between two or more power control states and: (a) two or more TCI states, (b) two or more UL channels, (c) two or more UL resources, (d) two or more UL resource sets, (e) two or more UL resource groups, or (f) any combination of two or more of (a)-(e).

In one embodiment, a base station comprises processing circuitry configured to cause the base station to provide, to one or more wireless communication devices, information that indicates associations between two or more power control states and: (a) two or more TCI states, (b) two or more UL channels, (c) two or more UL resources, (d) two or more UL resource sets, (e) two or more UL resource groups, or (f) any combination of two or more of (a)-(e).

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates data scheduling in New Radio (NR) which is typically in slot basis, where the first two symbols contain Physical Downlink Control Channel (PDCCH) and the rest contains physical shared data channel, either Physical Downlink Shared Channel (PDSCH) or Physical Uplink Shared Channel (PUSCH);

FIG. 2 illustrates a basic NR physical time-frequency resource grid where only one Resource Block (RB) within a 14-symbol slot is shown. One Orthogonal Frequency Division Multiplexing (OFDM) subcarrier during one OFDM symbol interval forms one Resource Element (RE);

FIG. 3 illustrates an example where a gNB consists of a transmission/reception point (TRP) with two downlink (DL) beams each associated with a Channel State Information Reference Signal (CSI-RS);

FIG. 4 is a Physical Uplink Control Channel (PUCCH) spatial relation Information Element (IE) that a UE can be configured in NR, it includes one of a Synchronization Signal Block (SSB) index, a CSI-RS resource identity (ID), and Sounding Reference Signal (SRS) resource ID as well as some power control parameters such as pathloss RS, closed-loop index, etc.;

FIG. 5 illustrates an example where one of a SSB index, a CSI-RS resource ID, and SRS resource ID is configured, according to some embodiments of the present disclosure;

FIG. 6 illustrates dynamically scheduled PUSCH, where a UE is configured by Radio Resource Control (RRC) with a list of P0-PUSCH-Alpha sets and a list of SRI-PUSCH-PowerControl information elements, according to some embodiments of the present disclosure;

FIG. 7 illustrates transmitting a PUCCH or PUSCH towards different TRPs, either simultaneously or in different times, according to some embodiments of the present disclosure;

FIG. 8 illustrates an example where a PDSCH is scheduled by a Downlink Control Information (DCI) and the corresponding Hybrid Automatic Repeat Request (HARQ) A/N is sent in a PUCCH which is repeated twice in time, one towards TRP #1 and the other towards TRP #2, according to some embodiments of the present disclosure;

FIG. 9 illustrates an example of PUSCH repetitions where two PUSCH repetitions for a same Transport Block (TB) are scheduled by a single DCI, each PUSCH occasion is towards a different TRP, according to some embodiments of the present disclosure;

FIG. 10 illustrates one example of a cellular communications system in which embodiments of the present disclosure may be implemented;

FIG. 11 illustrates an example of one RRC configured Power control state IE containing power control states for all UL channels, according to some embodiments of the present disclosure;

FIG. 12 illustrates an example of one RRC configured Power control state IE per UL channel, according to some embodiments of the present disclosure;

FIG. 13 illustrates an example of association between UL Transmission Configuration Indicator (TCI) state and Power control states being configured in UL TCI states, according to some embodiments of the present disclosure;

FIG. 14 illustrates an example of association between UL TCI state and Power control states being configured in an explicit list, according to some embodiments of the present disclosure;

FIG. 15 illustrates an example of implicit association between UL TCI state and Power control states through the different UL channel configurations, according to some embodiments of the present disclosure;

FIG. 16 illustrates an example of association between UL TCI state and Power control states implicitly through the UL channels/UL resource sets/UL resources, according to some embodiments of the present disclosure;

FIG. 17 illustrates an example of association between UL TCI state and Power control states for multi-TRP applications, according to some embodiments of the present disclosure;

FIG. 18 illustrates an example of association between UL TCI state and Power control states for multi-TRP applications, according to some embodiments of the present disclosure;

FIG. 19 illustrates an operation of a UE and a base station, according to some embodiments of the present disclosure;

FIG. 20 is a schematic block diagram of a radio access node according to some embodiments of the present disclosure;

FIG. 21 is a schematic block diagram that illustrates a virtualized embodiment of the radio access node according to some embodiments of the present disclosure;

FIG. 22 is a schematic block diagram of the radio access node according to some other embodiments of the present disclosure;

FIG. 23 is a schematic block diagram of a wireless communication device according to some embodiments of the present disclosure;

FIG. 24 is a schematic block diagram of the wireless communication device 1200 according to some other embodiments of the present disclosure;

FIG. 25 illustrates a communication system includes a telecommunication network, such as a 3GPP-type cellular network, which comprises an access network, such as a Radio Access Network (RAN), and a core network according to some embodiments of the present disclosure;

FIG. 26 illustrates a communication system including a host computer according to some embodiments of the present disclosure; and

FIGS. 27-30 are flowcharts illustrating methods implemented in a communication system, according to some embodiments of the present disclosure.

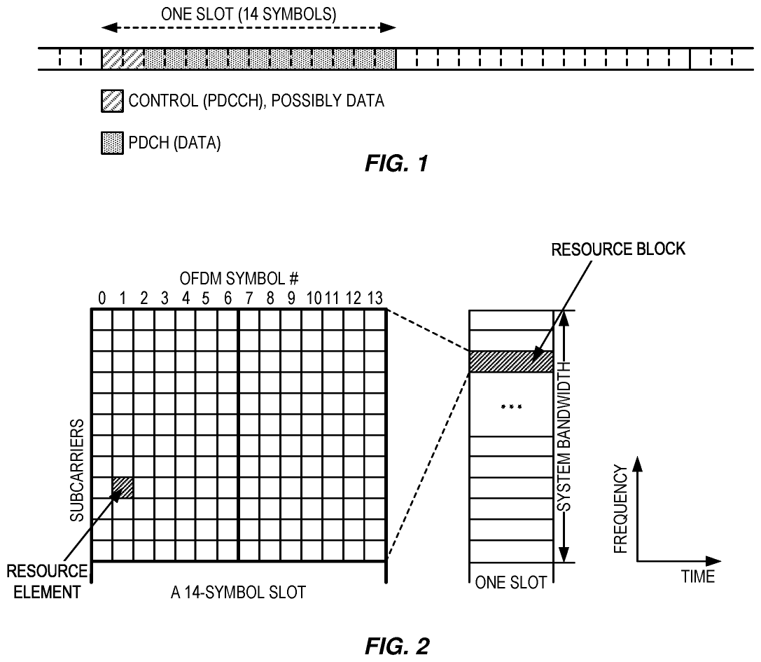

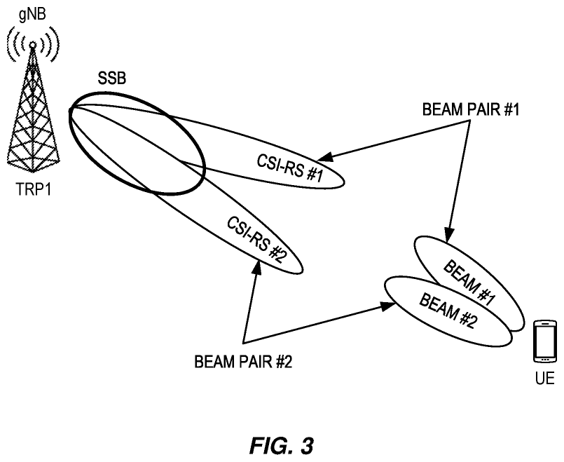

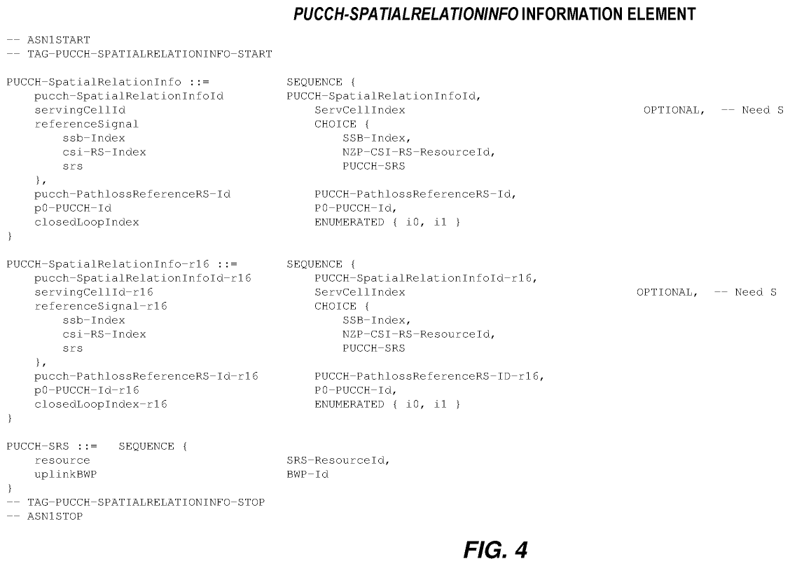

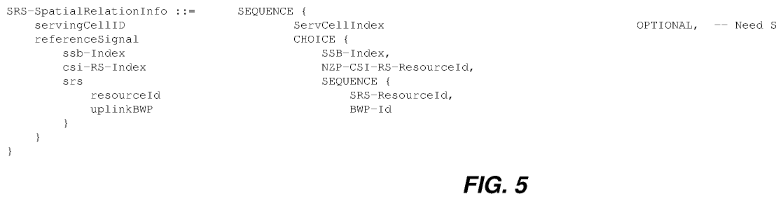

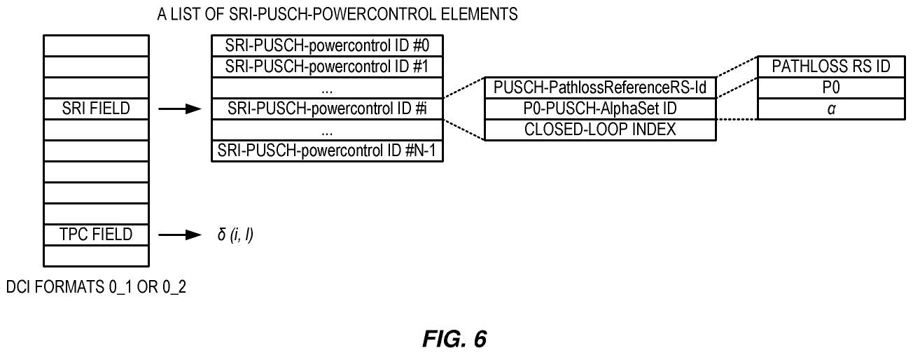

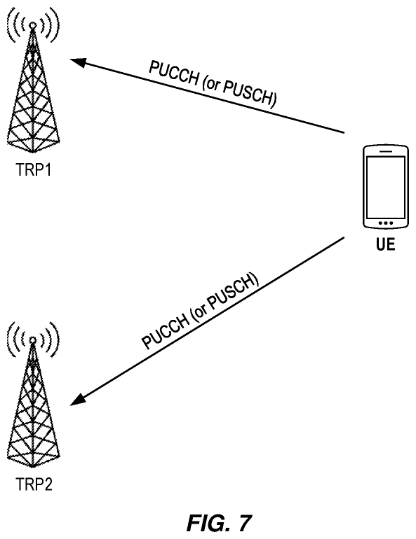

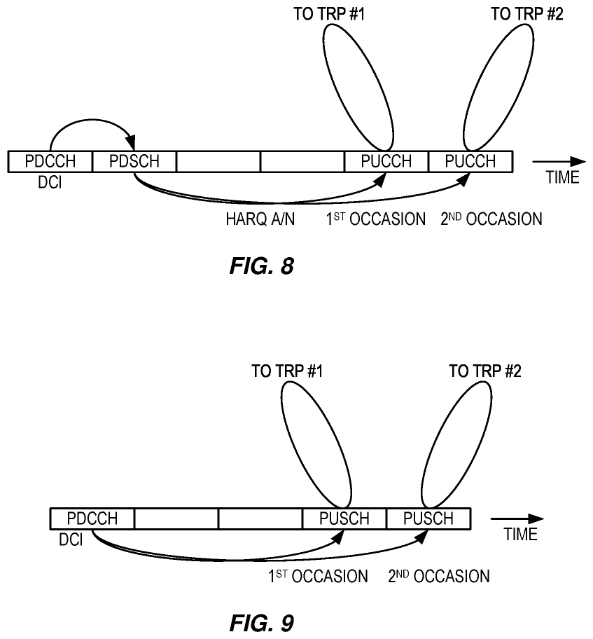

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

Radio Node: As used herein, a “radio node” is either a radio access node or a wireless communication device.

Radio Access Node: As used herein, a “radio access node” or “radio network node” or “radio access network node” is any node in a Radio Access Network (RAN) of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), a relay node, a network node that implements part of the functionality of a base station (e.g., a network node that implements a gNB Central Unit (gNB-CU) or a network node that implements a gNB Distributed Unit (gNB-DU)) or a network node that implements part of the functionality of some other type of radio access node.

Core Network Node: As used herein, a “core network node” is any type of node in a core network or any node that implements a core network function. Some examples of a core network node include, e.g., a Mobility Management Entity (MME), a Packet Data Network Gateway (P-GW), a Service Capability Exposure Function (SCEF), a Home Subscriber Server (HSS), or the like. Some other examples of a core network node include a node implementing an Access and Mobility Management Function (AMF), a User Plane Function (UPF), a Session Management Function (SMF), an Authentication Server Function (AUSF), a Network Slice Selection Function (NSSF), a Network Exposure Function (NEF), a Network Function (NF) Repository Function (NRF), a Policy Control Function (PCF), a Unified Data Management (UDM), or the like.

Communication Device: As used herein, a “communication device” is any type of device that has access to an access network. Some examples of a communication device include, but are not limited to: mobile phone, smart phone, sensor device, meter, vehicle, household appliance, medical appliance, media player, camera, or any type of consumer electronic, for instance, but not limited to, a television, radio, lighting arrangement, tablet computer, laptop, or Personal Computer (PC). The communication device may be a portable, hand-held, computer-comprised, or vehicle-mounted mobile device, enabled to communicate voice and/or data via a wireless or wireline connection.

Wireless Communication Device: One type of communication device is a wireless communication device, which may be any type of wireless device that has access to (i.e., is served by) a wireless network (e.g., a cellular network). Some examples of a wireless communication device include, but are not limited to: a User Equipment device (UE) in a 3GPP network, a Machine Type Communication (MTC) device, and an Internet of Things (IoT) device. Such wireless communication devices may be, or may be integrated into, a mobile phone, smart phone, sensor device, meter, vehicle, household appliance, medical appliance, media player, camera, or any type of consumer electronic, for instance, but not limited to, a television, radio, lighting arrangement, tablet computer, laptop, or PC. The wireless communication device may be a portable, hand-held, computer-comprised, or vehicle-mounted mobile device, enabled to communicate voice and/or data via a wireless connection.

Network Node: As used herein, a “network node” is any node that is either part of the RAN or the core network of a cellular communications network/system.

Transmission/Reception Point (TRP): In some embodiments, a TRP may be either a network node, a radio head, a spatial relation, or a Transmission Configuration Indicator (TCI) state. A TRP may be represented by a spatial relation or a TCI state in some embodiments. In some embodiments, a TRP may be using multiple TCI states. In some embodiments, a TRP may a part of the gNB transmitting and receiving radio signals to/from UE according to physical layer properties and parameters inherent to that element. In some embodiments, in Multiple TRP (multi-TRP) operation, a serving cell can schedule UE from two TRPs, providing better Physical Downlink Shared Channel (PDSCH) coverage, reliability and/or data rates. There are two different operation modes for multi-TRP: single Downlink Control Information (DCI) and multi-DCI. For both modes, control of uplink and downlink operation is done by both physical layer and Medium Access Control (MAC). In single-DCI mode, UE is scheduled by the same DCI for both TRPs and in multi-DCI mode, UE is scheduled by independent DCIs from each TRP.

In some embodiments, a set Transmission Points (TPs) is a set of geographically co-located transmit antennas (e.g., an antenna array (with one or more antenna elements)) for one cell, part of one cell or one Positioning Reference Signal (PRS)-only TP. TPs can include base station (eNB) antennas, Remote Radio Heads (RRHs), a remote antenna of a base station, an antenna of a PRS-only TP, etc. One cell can be formed by one or multiple TPs. For a homogeneous deployment, each TP may correspond to one cell.

In some embodiments, a set of TRPs is a set of geographically co-located antennas (e.g., an antenna array (with one or more antenna elements)) supporting TP and/or Reception Point (RP) functionality.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to 5G NR concepts, beams may be used instead of cells and, as such, it is important to note that the concepts described herein are equally applicable to both cells and beams.

In PCT Application PCT/IB2021/0055717 filed Jun. 29, 2021 (hereinafter “PCT0055717 Application”), which claims the benefit of U.S. Provisional Patent Application Ser. No. 63/044,851, the following is proposed for uplink power control in case UL TCI states are introduced for UL beam indication:
associating each UL TCI state with a set of power control parameters, and
different set of power control parameters being associated with a UL TCI state for Physical Uplink Control Channel (PUCCH), Physical Uplink Shared Channel (PUSCH), and Sounding Reference Signal (SRS).

Although the PCT0055717 Application discusses associating UL TCI state with a set of power control parameters (referred to as “power control states”), the PCT0055717 Application does not solve the problem of how the association between UL TCI states and power control states should be done. That is, what detailed signaling is needed to associate UL TCI states and power control states is still an open problem that needs to be solved.

Certain aspects of the present disclosure and their embodiments may provide solutions to the aforementioned or other challenges. This disclosure proposes a framework and signaling for associating power control states with UL TCI states and/or UL channels and/or UL resources and/or UL resource sets and/or UL resource groups.

Certain embodiments may provide one or more of the following technical advantage(s). Embodiments of the solutions disclosed herein enable efficient signaling to associate UL TCI states with power control states.

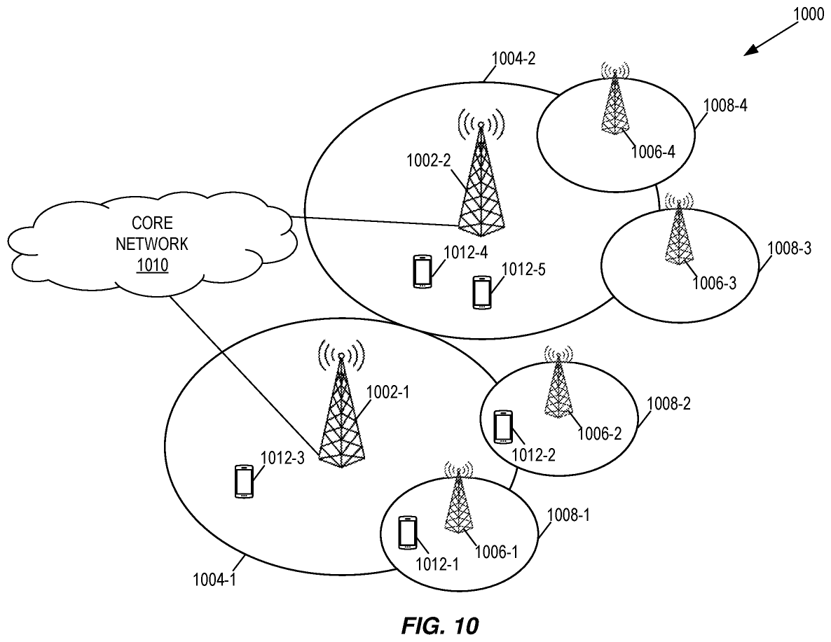

FIG. 10 illustrates one example of a cellular communications system 1000 in which embodiments of the present disclosure may be implemented. In the embodiments described herein, the cellular communications system 1000 is a 5G system (5GS) including a Next Generation RAN (NG-RAN) and a 5G Core (5GC); however, the embodiments of the solutions described herein are not limited thereto. In this example, the RAN includes base stations 1002-1 and 1002-2, which in the 5GS include NR base stations (gNBs) and optionally next generation eNBs (ng-eNBs) (e.g., LTE RAN nodes connected to the 5GC), controlling corresponding (macro) cells 1004-1 and 1004-2. The base stations 1002-1 and 1002-2 are generally referred to herein collectively as base stations 1002 and individually as base station 1002. Likewise, the (macro) cells 1004-1 and 1004-2 are generally referred to herein collectively as (macro) cells 1004 and individually as (macro) cell 1004. The RAN may also include a number of low power nodes 1006-1 through 1006-4 controlling corresponding small cells 1008-1 through 1008-4. The low power nodes 1006-1 through 1006-4 can be small base stations (such as pico or femto base stations) or RRHs, or the like. Notably, while not illustrated, one or more of the small cells 1008-1 through 1008-4 may alternatively be provided by the base stations 1002. The low power nodes 1006-1 through 1006-4 are generally referred to herein collectively as low power nodes 1006 and individually as low power node 1006. Likewise, the small cells 1008-1 through 1008-4 are generally referred to herein collectively as small cells 1008 and individually as small cell 1008. The cellular communications system 1000 also includes a core network 1010, which in the 5GS is referred to as the 5GC. The base stations 1002 (and optionally the low power nodes 1006) are connected to the core network 1010.

The base stations 1002 and the low power nodes 1006 provide service to wireless communication devices 1012-1 through 1012-5 in the corresponding cells 1004 and 1008. The wireless communication devices 1012-1 through 1012-5 are generally referred to herein collectively as wireless communication devices 1012 and individually as wireless communication device 1012. In the following description, the wireless communication devices 1012 are oftentimes UEs, but the present disclosure is not limited thereto.

If UL TCI states are introduced for UL beam indication in NR Rel-17, each UL TCI state can be associated with a set of power control parameters. For a given UL TCI state, different sets of power control parameters may be associated to PUCCH, PUSCH, and SRS. Each set of power control parameters may, for example, include one or more of P_{O}, α, a pathloss RS, and a closed loop index. Each such power control parameter set can be considered as a “power control state” with a power control state ID. Note that although the terminology “power control state” is used herein, other terms (e.g., “power control setting”) may alternatively be used in place of “power control state”. It is also possible that the path loss RS is configured in the UL TCI state, either explicitly or implicitly. In the implicit case, the DL Reference Signal (DL-RS) used as spatial relation in the UL TCI state is also used as path loss reference RS.

Different power control parameters might be needed for different UL TCI states and/or different UL channels. In a deployment scenario involving multiple TRPs, the channel conditions between the UE (e.g., UE 1012) and the multiple TRPs may be very different. Hence, it is beneficial to associate different power control parameters with different TRPs. For instance, different closed loop indices may need to be associated with different TRPs. Since different UL TCI states are used to transmit PUSCH/PUCCH/SRS towards different TRPs, it is also beneficial to associate different power control parameters with different UL TCI states.

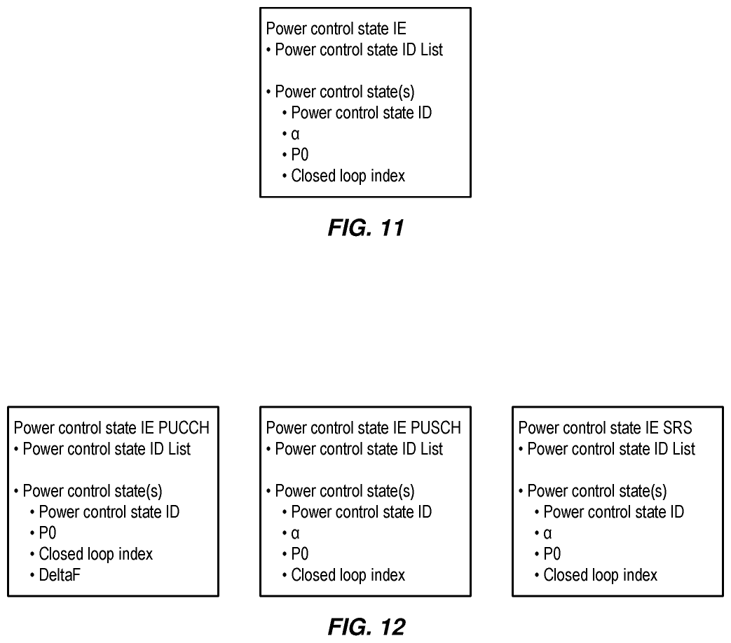

Given different power control parameters might be needed for different UL TCI states and/or different UL channels, there is a need to configure a UE with multiple different power control states. One way to do this is to configure a UE with a single power control state IE, where a list of power control states applicable for UL channels are configured, as schematically illustrated in FIG. 11. In the example of FIG. 11, one power control state IE is configured (e.g., Radio Resource Control (RRC) configured) for all UL channels. An alternative solution is to configure the UE with power control state IEs for the different UL channels, as schematically illustrated in FIG. 12. In the example of FIG. 12, one power control state IE is configured (e.g., RRC configured) per UL channel. In FIG. 11 and FIG. 12, the ‘Power control state ID List’ contains a list of ‘Power control state IDs’ wherein each ‘Power control state ID’ has a one-to-one mapping to a ‘Power Control State’.

Although the examples in FIG. 11 and FIG. 12 do not show pathloss RS being included as part of power control state(s), in some alternative embodiments, pathloss RS is also included as part of power control state(s).

For FR2 and/or multi-TRP communication, it is expected that a UE needs to be configured with multiple UL TCI states to indicate to the UE which beam pair link/TRP an UL transmission is associated with. Since different beam pair links/TRPs might require different UL output power, there is a need to associate different power control states with different UL TCI states. This could be done in different ways. First a number of embodiments are illustrated which involve an explicit association between UL TCI states and power control states. This is followed by disclosure of embodiments which involve an implicit association between UL TCI states and Power control states.

### EMBODIMENTS WITH EXPLICIT ASSOCIATION OF UL TCI STATES AND POWER CONTROL STATES

### Embodiment 1

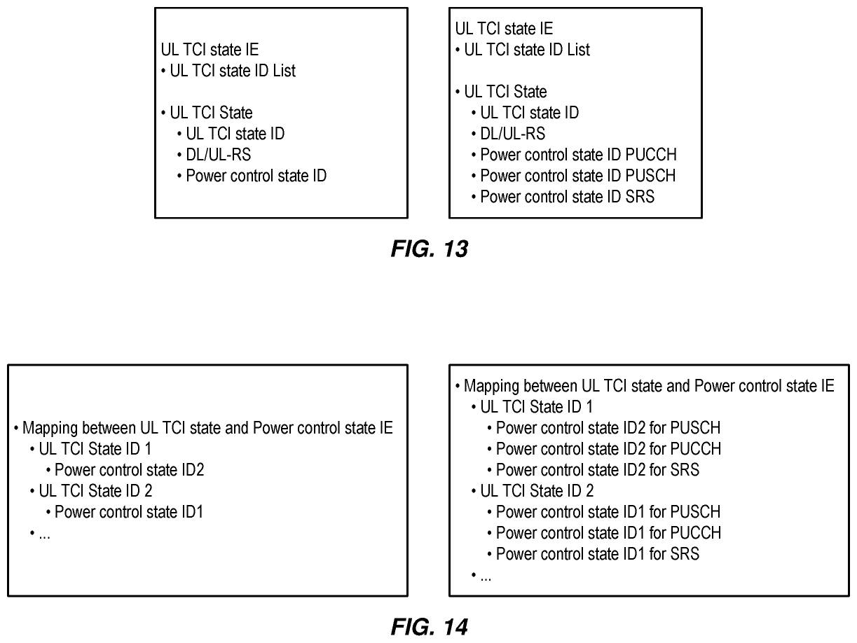

In Embodiment 1, the associations between UL TCI states and power control states are done in the UL TCI states configuration, as schematically illustrated in FIG. 13. The left side of FIG. 13 illustrates the case where all power control parameters applicable to all UL channels are configured in one single power control state IE, and the right side of FIG. 13 shows the case where a power control state IE is configured per UL channel.

### Embodiment 2

In Embodiment 2, the associations between UL TCI states and power control states are done in an explicit list (the explicit list can be a separate IE, or be configured in for example the Power control state IE), as schematically illustrated in FIG. 14. The left side of FIG. 14 illustrates the case where all power control parameters applicable to all UL channels are configured in one single power control state IE, and the right side of FIG. 14 shows the case where a power control state IE is configured per UL channel.

### Embodiments with Implicit Association of UL TCI States and Power Control States

For the embodiments related to implicit association between UL TCI states and power control states, it is assumed that path loss RS is included in the UL TCI state (either implicitly or explicitly).

### Embodiment 4

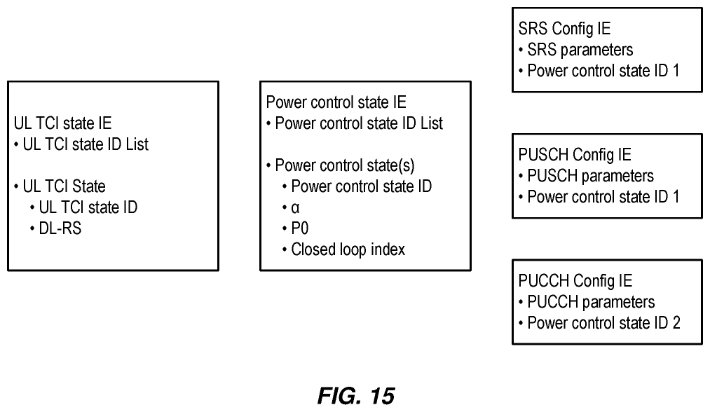

In Embodiment 4, the UL TCI states are implicitly associated to a power control state through the different UL channel configurations. In other words, in this embodiment, there are no specific association between a power control state and a UL TCI state; instead, there is only an association between the power control states and the UL channels. In a first example, each UL channel configuration is associated with a power control state ID as schematically illustrated in FIG. 15. In other words, FIG. 15 is an illustration of implicit association between UL TCI state and power control states through the different UL channel configurations. This means, for example, that when a UE is triggered with an SRS transmission with a certain UL TCI state (the UL TCI state can for example be included in the DCI triggering the SRS transmission or higher layer configured per SRS resource/SRS resource set), the UE applies the UL power control parameters included in the power control state indicated in SRS Config IE (Power control state Synchronization Signal in the example of FIG. 15). In a similar way, when a UE is triggered with PUCCH transmission, the UE applies the power control parameters included in the power control state indicated in PUCCH Config IE (i.e., Power control state ID 2 in the example of FIG. 15). Likewise, when a UE is triggered with PUSCH transmission, the UE applies the power control parameters included in the power control state indicated in PUSCH Config IE (i.e., Power control state ID 1 in the example of FIG. 15). Note that in this example the mapping between UL channels and power control states are configured in each UL channel configuration, but the association between an UL channel and a power control state can be done in other ways. For example, the association can be done in the power control state IE, or in a separate list.

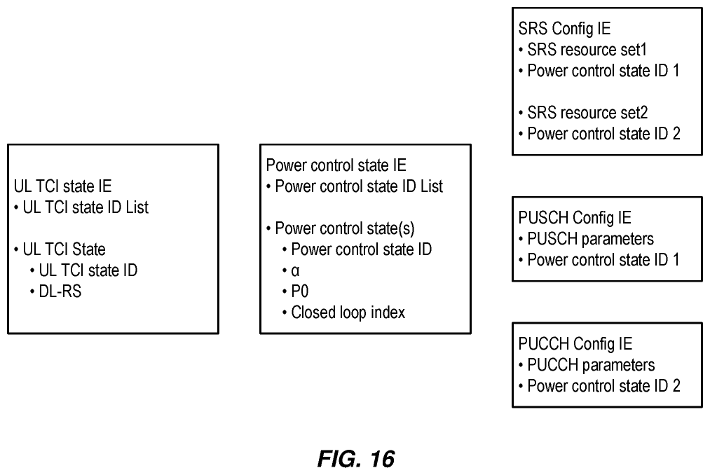

In the previous example of Embodiment 4, since a Power control state ID is implicitly associated with an UL channel, the same power control parameters will be applied to all transmissions of that UL channel. However, for example, different SRS resource sets (or PUCCH resources/PUCCH resource set/PUCCH resource groups) might have different link budget requirements, and hence different UL power control requirements may need to be associated with the different SRS resource sets. One way to solve this is to enable the possibility to associate a Power control state per UL channel resource set or UL channel resource. FIG. 16 illustrates one example of this where a Power control state ID is configured per SRS resource set. In a similar way, power control states can be configured per SRS resource, PUCCH resource, or PUCCH resource set. In some embodiments, the power control states can also be configured per PUCCH resource groups. Note that in this example the mapping between UL channels/SRS resource set and power control states are configured in the configuration of each UL channel/SRS resource set, but the association between an UL channel/SRS resource set and a power control state can be done in other places as well.

### Embodiment 5

In Embodiment 4, since a Power control state ID is associated with an UL channel/UL resource set/UL resource/UL resource group, the same power control parameters will be applied to that UL channel/UL resource set/UL resource/UL resource group regardless of used UL TCI state. This might be sub-optimal for example during multi-TRP communication, where it might be desirable to use different UL power control parameter settings for the different TRPs.

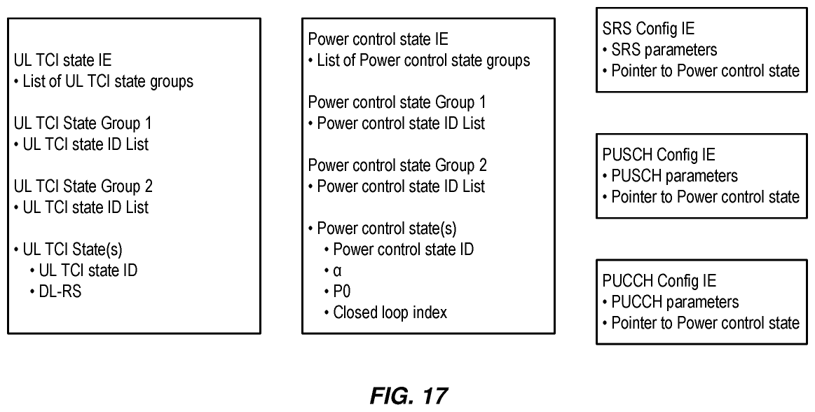

Embodiment 5 solves this problem by configuring a UE with two (or more) groups of UL TCI states and Power control states, where each group can be associated to one TRP. That is, in this embodiment, the group ID becomes essentially a TRP ID. However, it should be noted that the term TRP or TRP ID is not used in current specifications thus a more general term like group ID, or PUCCHPoolID is used. Further note that in DL, there exists CORESETPoolID and this PUCCHPoolID would resemble that one. One example of this is illustrated in FIG. 17, where the “UL TCI state IE” consists of two groups of UL TCI states and the “Power control state IE” consists of two groups of Power control states. When a UE for example is triggered with aperiodic SRS transmission indicating a UL TCI state in the DCI from “UL TCI state Group 1”, the UE knows that the “Pointer to Power control state” configured in the SRS Config 1E, points to a Power control state configured in “Power control state Group1”.

In the same way, if a UE for example is triggered with PUSCH transmission indicating a UL TCI state in the DCI from “UL TCI state Group 2”, the UE knows that the “Pointer to Power control state” configured in the PUSCH Config IE, points to a Power control state configured in “Power control state Group2”. For example, assume that “Pointer to Power control state”=2, then the UE should apply the Power control state placed as number two in the list of Power control states in “Power control state Group 2.

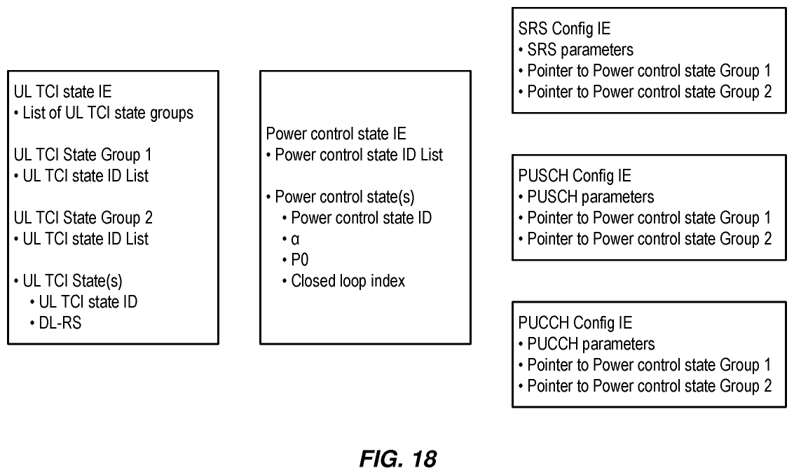

In one alternate of this embodiment, as illustrated in FIG. 18, there are two groups of UL TCI states, but only one group of power control states. Each UL channel/UL resource set/UL resource/UL resource group is then configured with one “Power control state pointer” per UL TCI state group. When a UE is triggered with for example aperiodic SRS transmission and where the DCI indicates a UL TCI state from group1, the UE will use the “Pointer to Power control state group 1” to identify the Power control state to apply.

Note that this embodiment can be configured in many different ways, but the core idea is to use two (or more) groups of UL TCI states, (where each group can be associated with one TRP), and depending on which group the UL TCI state indicated in DCI belongs to, the UE will apply different power control states.

In another embodiment, all parameters that are common towards an UL of a TRP are grouped under one IE and this IE has an ID. Note that TRP may not be explicitly specified in 3GPP specification; hence, the TRP in this case may be represented by the ID. Examples of common parameters associated with a TRP (i.e., the ID) could be pathloss RS or closed loop index. Then, for each UL channel or RS, SRS, PUCCH, PUSCH, the network configures parameter values that are specific to these channels or RS regardless of UL of a TRP, and additionally gives ID for the group of parameters that are common towards UL of a TRP.

### Embodiment 6

For UL multi-TRP transmission, more than one power control state may need to be indicated to the UE. If these power control states are independent and independently signaled for the UE, the total amount of needed bits in DCI may increase a lot.

In RRC, a set of full power control states may be configured and managed as described in earlier embodiments of the present disclosure. Additionally, a list of relative power control states may be configured per full power control state. For example, let us say that the UE is configured (e.g., RRC configured) with 8 relative power control states. When an indication of which of them to use is provided in a DCI, 3 bits are needed. However, if 8 relative power control states are configured (e.g., with RRC) and then 4 out of the 8 relative power control states are activated (e.g., via Medium Access Control (MAC) Control Element (CE)), only two bits are needed in the DCI to indicate which of the 4 activated relative power control states the UE should apply. A MAC CE may be used to down-select a subset of relative power control states and are then further indicated by DCI for the UE for the second TRP. In another embodiment, the relative part is only some of the parameters of the full power control state.

### Embodiment 7 Group Based TPC Command Signaling

An existing way to apply power control is to use group based signaling with DCI format 2_2 and 2_3, where 2_2 is used to transmit TPC commands for PUCCH/PUSCH and 2_3 is used to transmit TPC commands for SRS. Higher layer parameter tpc-PUSCH, tpc-PUCCH,startingBitOfFormat2-3, startingBitOfFormat2-3SUL-v1530 can be configured to indicate a starting position of a block for a UE to extract the power control information from the bit fields of the block DCI. Once multiple UL power control states are configured for a UL channel or a UL channel group for the UE:
the DCI field in the group common DCI 2_2 and 2_3 for the block indicated to the UE can be extended according to the number of power control configurations
   with ascending/descending order of the power control state ID being configured to the corresponding UL channel or channel group, or with an order indicated by RRC configuration;
   a. 2 bits each for each TPC command field associated with a configuration with different index ID.
   1 bit each if twoPUSCH-PC-AdjustmentStates being configured by higherlayer for any of the different power control state configurations associated with PUSCH-Config.
For DCI 2_2, UE assumes each block of the DCI format 2_2 is of the largest number of bits amongst its power control configurations when finding the starting bit for the block assigned to the UE, i.e., if UE is configured with twoPUSCH-PC-AdjustmentStates, 3 bit is assumed for each block, independent of the total number of configurations being configured by higherlayer. Similar rule applies for twoPUCCH-PC-AdjustmentStates. Thus, the starting bit position for all UEs in a cell, with or without multiple power control state configuration, maintains the same. UEs extract different length of the bit field for the corresponding power control information.
Another method for applying group based power control for a UL channel associated with multiple power control state is to select one of the power control configuration without extending the command bitfield. I.e. to apply rule as single DCI based power control for DCI 0_0 for PUSCH, or to apply to the configuration associated with lowest/highest configuration index.

Note that the notion of group has different meaning in Embodiment 7 than in Embodiments 5 and 6.

### Extension of the Proposed Solutions

Note that UL TCI state has been used in the present disclosure; however, it is possible that the TCI state is used also for DL channels, and might then be called something else like just TCI state or DL/UL TCI state.

### Additional Description

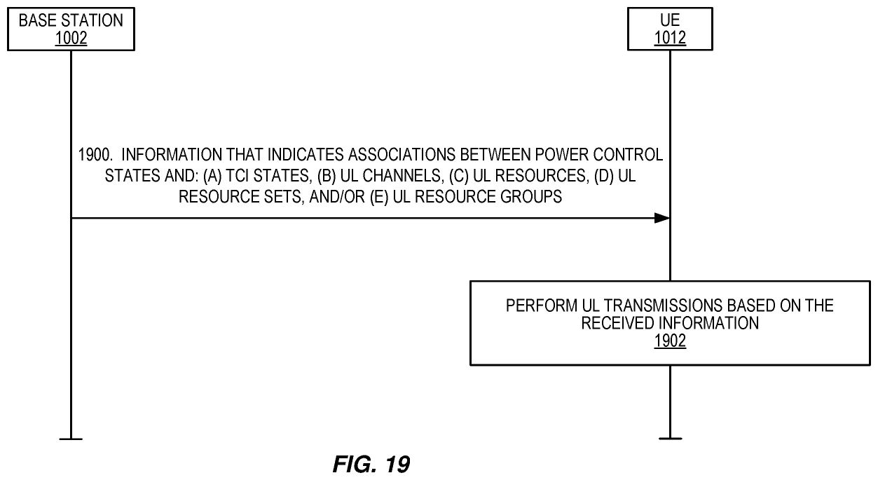

FIG. 19 illustrates the operation of a UE 1012 and a base station 1002 in accordance with at least some of the embodiments described above. As illustrated, the base station 1002 transmits and the UE 1012 receives information that indicates associations between power control states and: (a) TCI states, (b) UL channels, (c) UL resources, (d) UL resource sets, and/or (e) UL resource groups (step 1900). The received information may be in accordance with any of the embodiments described above (e.g., in accordance with any of Embodiments 1 to 7 described above). As discussed above, the associations may be indicated explicitly or implicitly. Further, the indications may define the associations, e.g., for all UL channels or per UL channel, for all UL resources or per UL resource, for all UL resource sets or per UL resource set, or for all UL resource groups or per UL resource group.

As discussed above, in Embodiment 1, the information that indicates the associations is explicitly included in UL TCI state configurations for all UL channels or per UL channel. As discussed above, in Embodiment 2, the information that indicates the associations is provided explicitly in a list (e.g., a separate IE or in, for example, a power control state IE for all UL channels or per UL channel). As discussed above, in Embodiment 4, the information that indicates the associations includes different UL channel configurations that include information that indicates associations between those UL channel configurations and associated power control states.

As discussed above with respect to Embodiment 5, in one embodiment, the UE 1012 is configured with two or more groups of UL TCI states and two or more group of power control states (e.g., where each group can be associated to one TRP). In this embodiment, the information that indicates the associations includes a pointer to a power control state and information that indicates an UL TCI state. In this manner, depending on which group of TCI states the indicated UL TCI state belongs to, the pointer to the power control state points to a respective pointer in a different group of power control states.

The UE 1012 then uses the received information to perform one or more UL transmissions (e.g., to perform UL power control for transmission of one or more UL channels or one or more UL signals) (step 1902).

Note that, in Embodiment 6, both a TCI state and a power control state ID are signaled in DCI. So, in this case, there are two different bit fields in the DCI that connects the TCI state with the power control state. So, this would be an explicit association, but instead of using RRC configuration to indicate the association, the association is done in DCI (e.g., in every DCI).

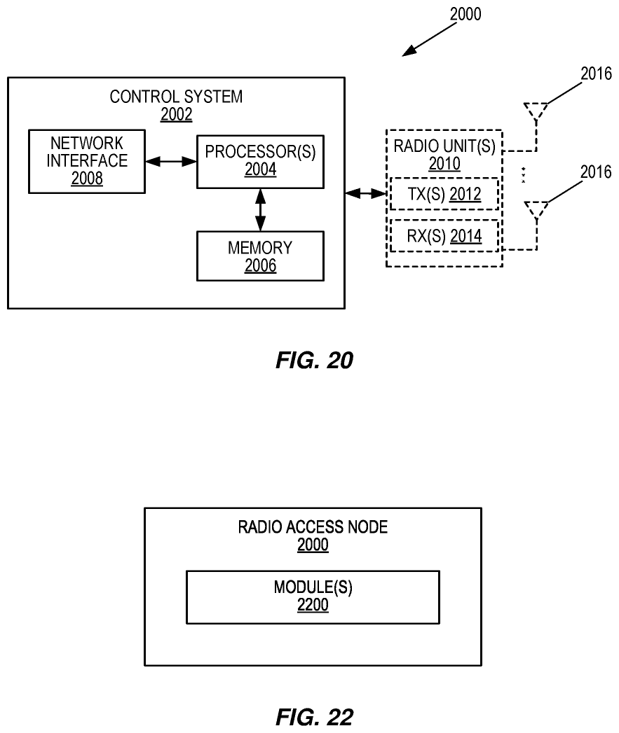

FIG. 20 is a schematic block diagram of a radio access node 2000 according to some embodiments of the present disclosure. Optional features are represented by dashed boxes. The radio access node 2000 may be, for example, a base station 1002 or 1006 or a network node that implements all or part of the functionality of the base station 1002 or gNB described herein. As illustrated, the radio access node 2000 includes a control system 2002 that includes one or more processors 2004 (e.g., Central Processing Units (CPUs), Application Specific Integrated Circuits (ASICs), Field Programmable Gate Arrays (FPGAs), and/or the like), memory 2006, and a network interface 2008. The one or more processors 2004 are also referred to herein as processing circuitry. In addition, the radio access node 2000 may include one or more radio units 2010 that each includes one or more transmitters 2012 and one or more receivers 2014 coupled to one or more antennas 2016. The radio units 2010 may be referred to or be part of radio interface circuitry. In some embodiments, the radio unit(s) 2010 is external to the control system 2002 and connected to the control system 2002 via, e.g., a wired connection (e.g., an optical cable). However, in some other embodiments, the radio unit(s) 2010 and potentially the antenna(s) 2016 are integrated together with the control system 2002. The one or more processors 2004 operate to provide one or more functions of the radio access node 2000 as described herein (e.g., one or more functions of a base station 1002 or gNB as described herein). In some embodiments, the function(s) are implemented in software that is stored, e.g., in the memory 2006 and executed by the one or more processors 2004.

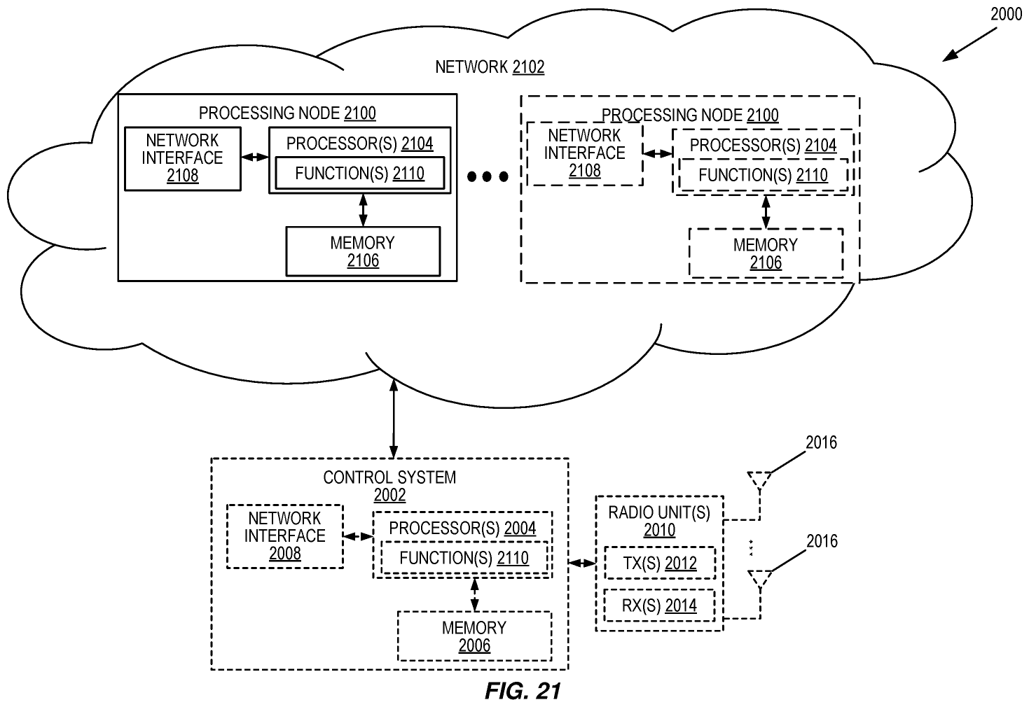

FIG. 21 is a schematic block diagram that illustrates a virtualized embodiment of the radio access node 2000 according to some embodiments of the present disclosure. This discussion is equally applicable to other types of network nodes. Further, other types of network nodes may have similar virtualized architectures. Again, optional features are represented by dashed boxes.

As used herein, a “virtualized” radio access node is an implementation of the radio access node 2000 in which at least a portion of the functionality of the radio access node 2000 is implemented as a virtual component(s) (e.g., via a virtual machine(s) executing on a physical processing node(s) in a network(s)). As illustrated, in this example, the radio access node 2000 may include the control system 2002 and/or the one or more radio units 2010, as described above. The control system 2002 may be connected to the radio unit(s) 2010 via, for example, an optical cable or the like. The radio access node 2000 includes one or more processing nodes 2100 coupled to or included as part of a network(s) 2102. If present, the control system 2002 or the radio unit(s) are connected to the processing node(s) 2100 via the network 2102. Each processing node 2100 includes one or more processors 2104 (e.g., CPUs, ASICs, FPGAs, and/or the like), memory 2106, and a network interface 2108.

In this example, functions 2110 of the radio access node 2000 described herein (e.g., one or more functions of a base station 1002 or gNB as described herein) are implemented at the one or more processing nodes 2100 or distributed across the one or more processing nodes 2100 and the control system 2002 and/or the radio unit(s) 2010 in any desired manner. In some particular embodiments, some or all of the functions 2110 of the radio access node 2000 described herein are implemented as virtual components executed by one or more virtual machines implemented in a virtual environment(s) hosted by the processing node(s) 2100. As will be appreciated by one of ordinary skill in the art, additional signaling or communication between the processing node(s) 2100 and the control system 2002 is used in order to carry out at least some of the desired functions 2110. Notably, in some embodiments, the control system 2002 may not be included, in which case the radio unit(s) 2010 communicate directly with the processing node(s) 2100 via an appropriate network interface(s).

In some embodiments, a computer program including instructions which, when executed by at least one processor, causes the at least one processor to carry out the functionality of radio access node 2000 or a node (e.g., a processing node 2100) implementing one or more of the functions 2110 of the radio access node 2000 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 22 is a schematic block diagram of the radio access node 2000 according to some other embodiments of the present disclosure. The radio access node 2000 includes one or more modules 2200, each of which is implemented in software. The module(s) 2200 provide the functionality of the radio access node 2000 described herein (e.g., one or more functions of a base station 1002 or gNB as described herein). This discussion is equally applicable to the processing node 2100 of FIG. 21 where the modules 2200 may be implemented at one of the processing nodes 2100 or distributed across multiple processing nodes 2100 and/or distributed across the processing node(s) 2100 and the control system 2002.

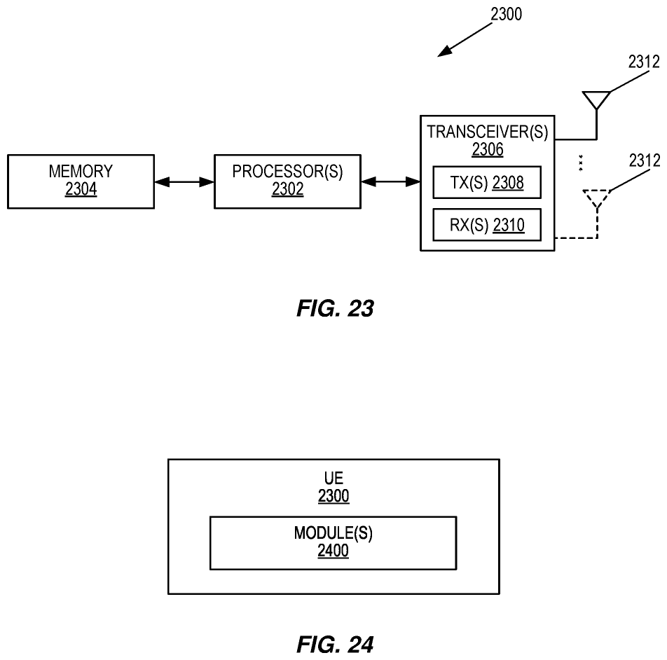

FIG. 23 is a schematic block diagram of a wireless communication device 2300 according to some embodiments of the present disclosure. The wireless communication device 2300 may be a UE such as UE 1012. As illustrated, the wireless communication device 2300 includes one or more processors 2302 (e.g., CPUs, ASICs, FPGAs, and/or the like), memory 2304, and one or more transceivers 2306 each including one or more transmitters 2308 and one or more receivers 2310 coupled to one or more antennas 2312. The transceiver(s) 2306 includes radio-front end circuitry connected to the antenna(s) 2312 that is configured to condition signals communicated between the antenna(s) 2312 and the processor(s) 2302, as will be appreciated by on of ordinary skill in the art. The processors 2302 are also referred to herein as processing circuitry. The transceivers 2306 are also referred to herein as radio circuitry. In some embodiments, the functionality of the wireless communication device 2300 described above (e.g., one or more functions of the UE 1012 or UE as described herein) may be fully or partially implemented in software that is, e.g., stored in the memory 2304 and executed by the processor(s) 2302. Note that the wireless communication device 2300 may include additional components not illustrated in FIG. 23 such as, e.g., one or more user interface components (e.g., an input/output interface including a display, buttons, a touch screen, a microphone, a speaker(s), and/or the like and/or any other components for allowing input of information into the wireless communication device 2300 and/or allowing output of information from the wireless communication device 2300), a power supply (e.g., a battery and associated power circuitry), etc.

In some embodiments, a computer program including instructions which, when executed by at least one processor, causes the at least one processor to carry out the functionality of the wireless communication device 2300 according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 24 is a schematic block diagram of the wireless communication device 2300 according to some other embodiments of the present disclosure. The wireless communication device 2300 includes one or more modules 2400, each of which is implemented in software. The module(s) 2400 provide the functionality of the wireless communication device 2300 described herein (e.g., one or more functions of the UE 1012 or UE as described herein).

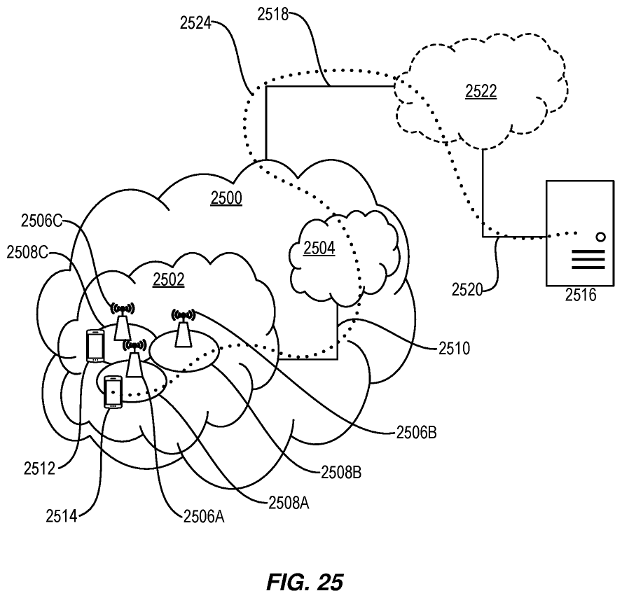

With reference to FIG. 25, in accordance with an embodiment, a communication system includes a telecommunication network 2500, such as a 3GPP-type cellular network, which comprises an access network 2502, such as a RAN, and a core network 2504. The access network 2502 comprises a plurality of base stations 2506A, 2506B, 2506C, such as Node Bs, eNBs, gNBs, or other types of wireless Access Points (APs), each defining a corresponding coverage area 2508A, 2508B, 2508C. Each base station 2506A, 2506B, 2506C is connectable to the core network 2504 over a wired or wireless connection 2510. A first UE 2512 located in coverage area 2508C is configured to wirelessly connect to, or be paged by, the corresponding base station 2506C. A second UE 2514 in coverage area 2508A is wirelessly connectable to the corresponding base station 2506A. While a plurality of UEs 2512, 2514 are illustrated in this example, the disclosed embodiments are equally applicable to a situation where a sole UE is in the coverage area or where a sole UE is connecting to the corresponding base station 2506.

The telecommunication network 2500 is itself connected to a host computer 2516, which may be embodied in the hardware and/or software of a standalone server, a cloud-implemented server, a distributed server, or as processing resources in a server farm. The host computer 2516 may be under the ownership or control of a service provider, or may be operated by the service provider or on behalf of the service provider. Connections 2518 and 2520 between the telecommunication network 2500 and the host computer 2516 may extend directly from the core network 2504 to the host computer 2516 or may go via an optional intermediate network 2522. The intermediate network 2522 may be one of, or a combination of more than one of, a public, private, or hosted network; the intermediate network 2522, if any, may be a backbone network or the Internet; in particular, the intermediate network 2522 may comprise two or more sub-networks (not shown).

The communication system of FIG. 25 as a whole enables connectivity between the connected UEs 2512, 2514 and the host computer 2516. The connectivity may be described as an Over-the-Top (OTT) connection 2524. The host computer 2516 and the connected UEs 2512, 2514 are configured to communicate data and/or signaling via the OTT connection 2524, using the access network 2502, the core network 2504, any intermediate network 2522, and possible further infrastructure (not shown) as intermediaries. The OTT connection 2524 may be transparent in the sense that the participating communication devices through which the OTT connection 2524 passes are unaware of routing of uplink and downlink communications. For example, the base station 2506 may not or need not be informed about the past routing of an incoming downlink communication with data originating from the host computer 2516 to be forwarded (e.g., handed over) to a connected UE 2512. Similarly, the base station 2506 need not be aware of the future routing of an outgoing uplink communication originating from the UE 2512 towards the host computer 2516.

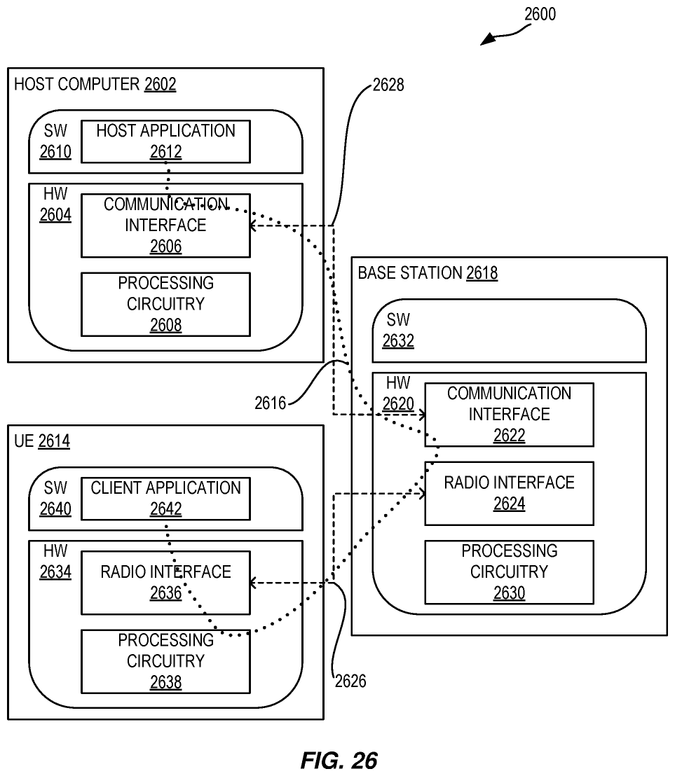

Example implementations, in accordance with an embodiment, of the UE, base station, and host computer discussed in the preceding paragraphs will now be described with reference to FIG. 26. In a communication system 2600, a host computer 2602 comprises hardware 2604 including a communication interface 2606 configured to set up and maintain a wired or wireless connection with an interface of a different communication device of the communication system 2600. The host computer 2602 further comprises processing circuitry 2608, which may have storage and/or processing capabilities. In particular, the processing circuitry 2608 may comprise one or more programmable processors, ASICs, FPGAs, or combinations of these (not shown) adapted to execute instructions. The host computer 2602 further comprises software 2610, which is stored in or accessible by the host computer 2602 and executable by the processing circuitry 2608. The software 2610 includes a host application 2612. The host application 2612 may be operable to provide a service to a remote user, such as a UE 2614 connecting via an OTT connection 2616 terminating at the UE 2614 and the host computer 2602. In providing the service to the remote user, the host application 2612 may provide user data which is transmitted using the OTT connection 2616.

The communication system 2600 further includes a base station 2618 provided in a telecommunication system and comprising hardware 2620 enabling it to communicate with the host computer 2602 and with the UE 2614. The hardware 2620 may include a communication interface 2622 for setting up and maintaining a wired or wireless connection with an interface of a different communication device of the communication system 2600, as well as a radio interface 2624 for setting up and maintaining at least a wireless connection 2626 with the UE 2614 located in a coverage area (not shown in FIG. 26) served by the base station 2618. The communication interface 2622 may be configured to facilitate a connection 2628 to the host computer 2602. The connection 2628 may be direct or it may pass through a core network (not shown in FIG. 26) of the telecommunication system and/or through one or more intermediate networks outside the telecommunication system. In the embodiment shown, the hardware 2620 of the base station 2618 further includes processing circuitry 2630, which may comprise one or more programmable processors, ASICs, FPGAs, or combinations of these (not shown) adapted to execute instructions. The base station 2618 further has software 2632 stored internally or accessible via an external connection.

The communication system 2600 further includes the UE 2614 already referred to. The UE's 2614 hardware 2634 may include a radio interface 2636 configured to set up and maintain a wireless connection 2626 with a base station serving a coverage area in which the UE 2614 is currently located. The hardware 2634 of the UE 2614 further includes processing circuitry 2638, which may comprise one or more programmable processors, ASICs, FPGAs, or combinations of these (not shown) adapted to execute instructions. The UE 2614 further comprises software 2640, which is stored in or accessible by the UE 2614 and executable by the processing circuitry 2638. The software 2640 includes a client application 2642. The client application 2642 may be operable to provide a service to a human or non-human user via the UE 2614, with the support of the host computer 2602. In the host computer 2602, the executing host application 2612 may communicate with the executing client application 2642 via the OTT connection 2616 terminating at the UE 2614 and the host computer 2602. In providing the service to the user, the client application 2642 may receive request data from the host application 2612 and provide user data in response to the request data. The OTT connection 2616 may transfer both the request data and the user data. The client application 2642 may interact with the user to generate the user data that it provides.

It is noted that the host computer 2602, the base station 2618, and the UE 2614 illustrated in FIG. 26 may be similar or identical to the host computer 2516, one of the base stations 2506A, 2506B, 2506C, and one of the UEs 2512, 2514 of FIG. 25, respectively. This is to say, the inner workings of these entities may be as shown in FIG. 26 and independently, the surrounding network topology may be that of FIG. 25.

In FIG. 26, the OTT connection 2616 has been drawn abstractly to illustrate the communication between the host computer 2602 and the UE 2614 via the base station 2618 without explicit reference to any intermediary devices and the precise routing of messages via these devices. The network infrastructure may determine the routing, which may be configured to hide from the UE 2614 or from the service provider operating the host computer 2602, or both. While the OTT connection 2616 is active, the network infrastructure may further take decisions by which it dynamically changes the routing (e.g., on the basis of load balancing consideration or reconfiguration of the network).

The wireless connection 2626 between the UE 2614 and the base station 2618 is in accordance with the teachings of the embodiments described throughout this disclosure. One or more of the various embodiments improve the performance of OTT services provided to the UE 2614 using the OTT connection 2616, in which the wireless connection 2626 forms the last segment.

A measurement procedure may be provided for the purpose of monitoring data rate, latency, and other factors on which the one or more embodiments improve. There may further be an optional network functionality for reconfiguring the OTT connection 2616 between the host computer 2602 and the UE 2614, in response to variations in the measurement results. The measurement procedure and/or the network functionality for reconfiguring the OTT connection 2616 may be implemented in the software 2610 and the hardware 2604 of the host computer 2602 or in the software 2640 and the hardware 2634 of the UE 2614, or both. In some embodiments, sensors (not shown) may be deployed in or in association with communication devices through which the OTT connection 2616 passes; the sensors may participate in the measurement procedure by supplying values of the monitored quantities exemplified above, or supplying values of other physical quantities from which the software 2610, 2640 may compute or estimate the monitored quantities. The reconfiguring of the OTT connection 2616 may include message format, retransmission settings, preferred routing, etc.; the reconfiguring need not affect the base station 2618, and it may be unknown or imperceptible to the base station 2618. Such procedures and functionalities may be known and practiced in the art. In certain embodiments, measurements may involve proprietary UE signaling facilitating the host computer 2602's measurements of throughput, propagation times, latency, and the like. The measurements may be implemented in that the software 2610 and 2640 causes messages to be transmitted, in particular empty or ‘dummy’ messages, using the OTT connection 2616 while it monitors propagation times, errors, etc.

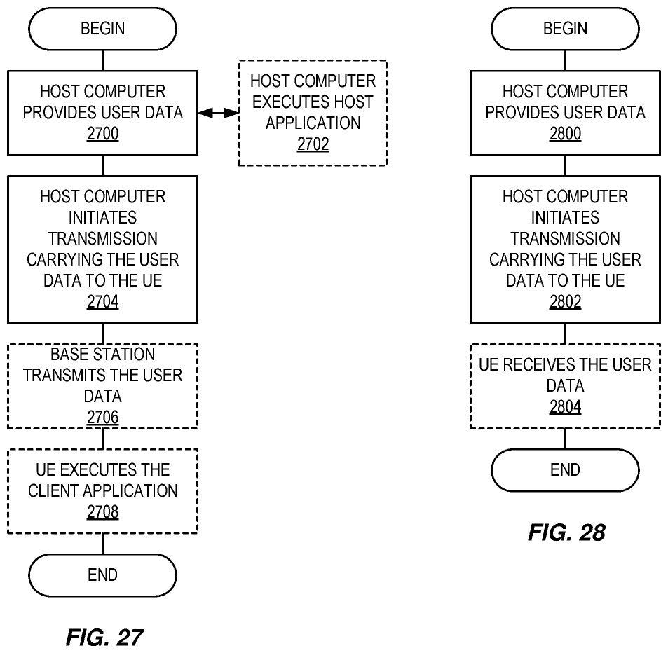

FIG. 27 is a flowchart illustrating a method implemented in a communication system, in accordance with one embodiment. The communication system includes a host computer, a base station, and a UE which may be those described with reference to FIGS. 25 and 26. For simplicity of the present disclosure, only drawing references to FIG. 27 will be included in this section. In step 2700, the host computer provides user data. In sub-step 2702 (which may be optional) of step 2700, the host computer provides the user data by executing a host application. In step 2704, the host computer initiates a transmission carrying the user data to the UE. In step 2706 (which may be optional), the base station transmits to the UE the user data which was carried in the transmission that the host computer initiated, in accordance with the teachings of the embodiments described throughout this disclosure. In step 2708 (which may also be optional), the UE executes a client application associated with the host application executed by the host computer.

FIG. 28 is a flowchart illustrating a method implemented in a communication system, in accordance with one embodiment. The communication system includes a host computer, a base station, and a UE which may be those described with reference to FIGS. 25 and 26. For simplicity of the present disclosure, only drawing references to FIG. 28 will be included in this section. In step 2800 of the method, the host computer provides user data. In an optional sub-step (not shown) the host computer provides the user data by executing a host application. In step 2802, the host computer initiates a transmission carrying the user data to the UE. The transmission may pass via the base station, in accordance with the teachings of the embodiments described throughout this disclosure. In step 2804 (which may be optional), the UE receives the user data carried in the transmission.

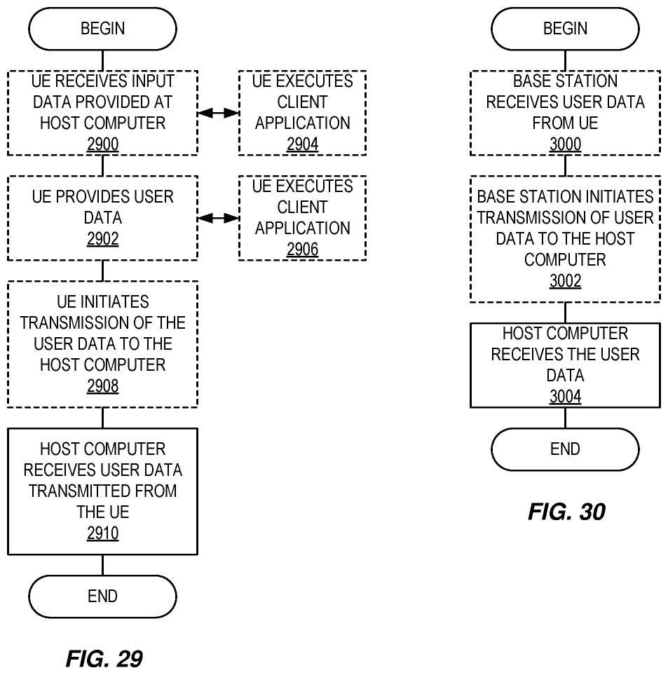

FIG. 29 is a flowchart illustrating a method implemented in a communication system, in accordance with one embodiment. The communication system includes a host computer, a base station, and a UE which may be those described with reference to FIGS. 25 and 26. For simplicity of the present disclosure, only drawing references to FIG. 29 will be included in this section. In step 2900 (which may be optional), the UE receives input data provided by the host computer. Additionally or alternatively, in step 2902, the UE provides user data. In sub-step 2904 (which may be optional) of step 2900, the UE provides the user data by executing a client application. In sub-step 2906 (which may be optional) of step 2902, the UE executes a client application which provides the user data in reaction to the received input data provided by the host computer. In providing the user data, the executed client application may further consider user input received from the user. Regardless of the specific manner in which the user data was provided, the UE initiates, in sub-step 2908 (which may be optional), transmission of the user data to the host computer. In step 2910 of the method, the host computer receives the user data transmitted from the UE, in accordance with the teachings of the embodiments described throughout this disclosure.

FIG. 30 is a flowchart illustrating a method implemented in a communication system, in accordance with one embodiment. The communication system includes a host computer, a base station, and a UE which may be those described with reference to FIGS. 25 and 26. For simplicity of the present disclosure, only drawing references to FIG. 30 will be included in this section. In step 3000 (which may be optional), in accordance with the teachings of the embodiments described throughout this disclosure, the base station receives user data from the UE. In step 3002 (which may be optional), the base station initiates transmission of the received user data to the host computer. In step 3004 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

At least some of the following abbreviations may be used in this disclosure. If there is an inconsistency between abbreviations, preference should be given to how it is used above. If listed multiple times below, the first listing should be preferred over any subsequent listing(s).
3GPP Third Generation Partnership Project
5G Fifth Generation
5GC Fifth Generation Core
5GS Fifth Generation System
AMF Access and Mobility Function
AN Access Network
ASIC Application Specific Integrated Circuit
AUSF Authentication Server Function
BWP bandwidth part
CE Control Element
CP-OFDM Cyclic Prefix Orthogonal Frequency Division Multiplexing
CPU Central Processing Unit
CRC Cyclic Redundancy Check
CSI-RS Channel State Information Reference Signal
DCI Downlink Control Information
DFT Discrete Fourier Transform
DL Downlink
DMRS DeModulation Reference Signal
DN Data Network
DSP Digital Signal Processor
eNB Enhanced or Evolved Node B
EPS Evolved Packet System
E-UTRA Evolved Universal Terrestrial Radio Access
FPGA Field Programmable Gate Array
FR Frequency Range
gNB New Radio Base Station
gNB-DU New Radio Base Station Distributed Unit
HARQ Hybrid Automatic Repeat Request
HSS Home Subscriber Server
IE information element
IoT Internet of Things
IP Internet Protocol
LTE Long Term Evolution
MAC Medium Access Control
MCS Modulation and Coding Scheme
MME Mobility Management Entity
MTC Machine Type Communication
NEF Network Exposure Function
NF Network Function
NR New Radio
NRF Network Function Repository Function
NSSF Network Slice Selection Function
OFDM Orthogonal Frequency Division Multiplexing
OTT Over-the-Top
PBCH Physical Broadcast Channel
PC Personal Computer
PCF Policy Control Function
PDCCH Physical Downlink Control Channel
PDSCH Physical Downlink Shared Channel
P-GW Packet Data Network Gateway
PRS Positioning Reference Signal
PUCCH Physical Uplink Control Channel
PUSCH Physical Uplink Shared Channel
QCL Quasi co-located
QoS Quality of Service
RAM Random Access Memory
RAN Radio Access Network
RBs Resource Blocks
RE Resource Element
RF Radio Frequency
ROM Read Only Memory
RP Reception Point
RRC Radio Resource Control
RRH Remote Radio Head
RS Reference Signal
RTT Round Trip Time
SCEF Service Capability Exposure Function
SMF Session Management Function
SPS Semi-Persistently Scheduled
SRI SRS Resource Indicator
SRS Sounding Reference Signal
SS Synchronization Signal
SSB Synchronization Signal Block
TB Transport Block
TCI Transmission Configuration Indicator
TP Transmission Point
TPC Transmit Power Control
TRP Transmission/Reception Point; Transmission Point
TRS Tracking Reference Signal
UDM Unified Data Management
UE User Equipment
UL Uplink
UPF User Plane Function
URLLC Ultra-Reliable Low-Latency Communication

Those skilled in the art will recognize improvements and modifications to the embodiments of the present disclosure. All such improvements and modifications are considered within the scope of the concepts disclosed herein.

1. A method performed by a wireless communication device, comprising:
obtaining information that indicates associations between two or more power control states and: (a) two or more Transmission Configuration Indicator, TCI, states, (b) two or more uplink, UL, channels, (c) two or more UL resources, (d) two or more UL resource sets, (e) two or more UL resource groups, or (f) any combination of two or more of (a)-(e); and
performing one or more UL transmissions based on the information.

2. The method of claim 1 wherein the two or more TCI states are two or more uplink, UL, TCI states.

3. The method of claim 1 wherein the information indicates associations between the two or more power control states and the (a) two or more TCI states.

4. The method of claim 1 wherein the information indicates associations between the two or more power control states and the (b) two or more UL channels.

5. The method of claim 1 wherein the information indicates associations between the two or more power control states and the (c) two or more UL resources.

6. The method of claim 1 wherein the information indicates associations between the two or more power control states and the (d) two or more UL resource sets.

7. The method of claim 1 wherein the information indicates associations between the two or more power control states and the (e) two or more UL resource groups.

8. The method of claim 1 wherein the information further comprises an uplink channel configuration that implicitly associates two or more TCI sates to a power control state.

9. The method of claim 1 wherein each power control state of the two or more power control states comprises one or more UL power control related parameters.

10. The method of claim 9 wherein the one or more UL power control related parameters comprise: (i) P_O, (ii) α, (iii) a pathloss Reference Signal, RS, (iv) a closed loop index, or (v) any combination of two or more of (i)-(iv).

11. The method of claim 1 wherein the information further indicates associations between the two or more power states and the two or more TCI states for all UL channels, all UL resources, all UL resource sets, or all UL resource groups.

12. The method of claim 1 wherein the information further indicates associations between the two or more power states and the two or more TCI states on a per UL channel, per UL resource, per UL resource set, and/or per UL resource group basis.

13. The method of claim 1 wherein the information is comprised explicitly in TCI state configurations for the two or more TCI states.

14. The method of claim 13 wherein the information comprises configuration of an identifier of a power control state in the configuration of each of the two or more TCI states.

15. The method of claim 14 wherein the information is applicable to at least one of (1) a Physical Uplink Control Channel, PUCCH; (2) a Physical Uplink Shared Channel, PUSCH; and (3) a Sounding Reference Signal, SRS.

16. The method of claim 13 wherein the information comprises configuration of one or more identifiers of one or more power control states in the configuration of each of the two or more TCI states.

17. The method of claim 16 wherein the one or more identifiers are specific to at least one of (1) a Physical Uplink Control Channel, PUCCH; (2) a Physical Uplink Shared Channel, PUSCH; and (3) a Sounding Reference Signal, SRS.

18-28. (canceled)

29. A wireless communication device comprising:
one or more transmitters;
one or more receivers; and
processing circuitry associated with the one or more transmitters and the one or more receivers, the processing circuitry configured to cause the wireless communication device to:
obtain information that indicates associations between two or more power control states and: (a) two or more Transmission Configuration Indicator, TCI, states, (b) two or more uplink, UL, channels, (c) two or more UL resources, (d) two or more UL resource sets, (e) two or more UL resource groups, or (f) any combination of two or more of (a)-(e); and
perform one or more UL transmissions based on the information.

30. (canceled)

31. A method performed by a base station, comprising:
providing, to one or more wireless communication devices, information that indicates associations between two or more power control states and: (a) two or more Transmission Configuration Indicator, TCI, states, (b) two or more UL channels, (c) two or more uplink, UL, resources, (d) two or more UL resource sets, (e) two or more UL resource groups, or (f) any combination of two or more of (a)-(e).

32-57. (canceled)

58. A base station comprising processing circuitry configured to cause the base station to:
provide, to one or more wireless communication devices, information that indicates associations between two or more power control states and: (a) two or more Transmission Configuration Indicator, TCI, states, (b) two or more UL channels, (c) two or more uplink, UL, resources, (d) two or more UL resource sets, (e) two or more UL resource groups, or (f) any combination of two or more of (a)-(e).

59. (canceled)
